(19) United States
(12) Patent Application Publication
(10) Pub. No.: US 2023/0415395 A1
(43) Pub. Date: Dec. 28, 2023

(54) MOLDED ARTICLE, PRODUCTION METHOD FOR LASER-MARKED MOLDED ARTICLE, AND LASER MARKING METHOD

(71) Applicant: ASAHI KASEI KABUSHIKI KAISHA, Tokyo (JP)

(72) Inventors: Kenta HIWATASHI, Tokyo (JP); Takayuki WAKITA, Tokyo (JP)

(73) Assignee: ASAHI KASEI KABUSHIKI KAISHA, Tokyo (JP)

(21) Appl. No.: 18/037,656

(22) PCT Filed: Mar. 11, 2022
(86) PCT No.: PCT/JP2022/010805

§ 371 Date: May 18, 2023

(30) Foreign Application Priority Data
Mar. 12, 2021 (JP) 2021-040597

(51) Int. Cl. B29C 48/00; B29C 48/03; C08G 69/02; C08K 3/04; C08K 5/5397

(52) U.S. Cl. CPC B29C 48/022; B29C 48/03; C08G 69/02; C08K 3/04; C08K 5/5397; B29K 2077/10

(57) ABSTRACT

According to the present invention, a molded article formed by molding a resin composition containing a thermoplastic resin (A) has a foam identifying part, and the developed interfacial area ratio Sdr of the foam identifying part, as stipulated by ISO 25178, is 0.10-1.00 inclusive, and the projection height of the foam identifying part is 6.6 μm-100.0 μm inclusive.

### TECHNICAL FIELD

The present invention relates to a molded article, a method of producing a laser marked molded article, and a laser marking method.

The present invention claims priority on the basis of Japanese Patent Application No. 2021-040597 filed in Japan on Mar. 12, 2021, the contents of which are incorporated herein by reference.

### BACKGROUND ART

As a conventional method of indicating a product name, manufacturing number, precaution statement, or the like, on a resin molded article, a method of attaching a sticker printed with such information, or various printing methods such as tampo printing or silk printing have been used.

The above-mentioned recording method has problems such as unfavorable printing due to scattering of the recording liquid, and difficulty in printing on uneven parts or printing of fine characters. In addition, the method of adhering the seal is also limited by the fact that the surface of the molded article is required to be smooth. Therefore, in recent years, a marking technique using a laser (hereinafter, referred to as “laser marking”) has come to be used to solve such problems. Laser marking is a technique that realizes high-speed marking with good reproducibility, and is an extremely useful method that does not cause the above-mentioned defects.

However, laser marking is not necessarily a technique that can be applied to all resins alone, and improvements in laser marking properties are generally being studied by improving the resin itself or various additives.

For example, PLT 1 proposes improving the marking properties of transparent polyamide.

In addition, PLT 2 proposes a polyamide resin composition having excellent laser marking properties.

### CITATION LIST

### Patent Literature

[PLT 1] Japanese Unexamined Patent Application, First Publication No. 2009-149896
[PLT 2] Japanese Unexamined Patent Application, First Publication No. 2009-035656

### SUMMARY OF INVENTION

### Technical Problem

However, improvement in the clearness of marking on opaque articles, which are used in large amounts, has not been achieved by the technique disclosed in PLT 1. In addition to a large amount of character information printed on the seal, complex graphics such as QR codes (registered trademark) that can hold large amounts of information for traceability are often printed by laser marking. Therefore, the technique disclosed in PLT 2 has room for improvement in terms of print clearness.

In addition, fillers, generally called fillers, are often added to polyamides in order to impart mechanical properties and functions such as reinforcement, shrinkage suppression, and flame-retardant adjuvant. It is generally known that the filler tends to be exposed on the surface of a polyamide. When the filler is exposed on the surface, the color changes compared to the case in which no filler is included. Therefore, there is a problem in that the polyamide to which a filler is added further deteriorates the laser marking clearness.

The present invention has been made in view of the above-mentioned circumstances, and provides a molded article with clear printing generated by laser marking, a method of producing the molded article, and a laser marking method that provides clear printing.

### Solution to Problem

The present invention includes the following aspects.

(1) A molded article obtained by molding a resin composition containing a thermoplastic resin (A), the molded article having a foam identifying part, wherein

the developed interfacial area ratio Sdr defined by ISO 25178 in the foam identifying part is 0.10 to 1.00, and

the projection height of the foam identifying part is 6.6 μm to 100.0 μm.

(2) The molded article according to (1), wherein the thermoplastic resin (A) includes a polyamide-based resin (A1).

(3) The molded article according to (2), wherein the polyamide-based resin (A1) is

a semi-aromatic polyamide (A1-2) containing an aromatic ring in the skeleton thereof, or

an alloy of the semi-aromatic polyamide (A1-2) and an aliphatic polyamide (A1-1).

(4) The molded article according to (3), wherein the semi-aromatic polyamide (A1-2) contains 10% by mol or more of isophthalic acid units relative to 100% by mol of all constituent dicarboxylic acid units.

(5) The molded article according to any one of (1) to (4), wherein the resin composition has a glass transition temperature of 75° C. or more.

(6) The molded article according to any one of (1) to (5), wherein the resin composition has a crystallization peak temperature of 240° C. or less.

(7) The molded article according to any one of (1) to (6), wherein the resin composition further contains a filler (B).

(8) The molded article according to (7), wherein the resin composition contains the filler (B) in an amount of more than 0 parts by mass and 150.0 parts by mass or less relative to 100 parts by mass of the thermoplastic resin (A).

(9) The molded article according to (7) or (8), wherein the filler (B) is at least one selected from the group consisting of glass fiber, calcium carbonate, talc, mica, wollastonite, and milled fiber.

(10) The molded article according to any one of (1) to (9), wherein the resin composition further contains a flame retardant (C).

(11) The molded article according to (10), wherein the flame retardant (C) is at least one selected from the group consisting of phosphinates and diphosphinates.

(12) The molded article according to (11), wherein

the phosphinates are compounds of the following general formula (I), and

the diphosphinates are compounds of the following general formula (II).

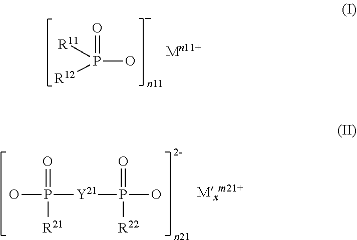

(In the general formula (1), R¹¹ and R¹² are each independently a C1-6 alkyl group or a C6-10 aryl group. Mⁿ¹¹⁺ is an n11-valent metal ion. M is an element in Group 2 or Group 15 of the periodic table, a transition element, zinc or aluminum. n11 is 2 or 3. Multiple R¹¹ and R¹² are identical to or different from each other.

In the general formula (2), R²¹ and R²² are each independently a C1-6 alkyl group or a C6-10 aryl group. Y²¹ is a C1-10 alkylene group or a C6-10 arylene group. M′^{m21+} is an m21-valent metal ion. M′ is an element in Group 2 or Group 15 of the periodic table, a transition element, zinc or aluminum. n21 is an integer of 1 to 3. When n21 is 2 or 3, multiple R²¹, R²² and Y²¹ are identical to or different from each other. m21 is 2 or 3. x is 1 or 2. When x is 2, multiple M′ is identical to or different from each other. n21, x and m21 are integers that satisfy an equation of 2×n21=m21×x).

(13) The molded article according to any one of (1) to (12), wherein the resin composition further contains a coloring agent (D) that develops a black, gray, or orange (chromatic) color.

(14) The molded article according to (13), wherein the coloring agent (D) contains a carbon black (D1), and

the amount of the carbon black (D1) relative to 100 parts by mass of the thermoplastic resin (A) is 0.001 parts by mass to 5.00 parts by mass.

(15) The molded article according to any one of (1) to (14), wherein the molded article is a magnet switch housing, a breaker housing, or a connector molded article.

(16) A method of producing a laser marked molded article, including:

a step of laser marking a molded article obtained by molding a resin composition containing a thermoplastic resin (A), such that the step makes the developed interfacial area ratio Sdr defined by ISO 25178 in a laser marked portion of the molded article be 0.10 to 1.00 and the projection height of the laser marked portion be 6.6 μm to 100.0 μm.

(17) A laser marking method comprising laser marking a molded article obtained by molding a resin composition comprising a thermoplastic resin (A) such that laser marking makes a developed interfacial area ratio Sdr defined by ISO 25178 in a laser marked portion of the molded article be 0.10 to 1.00.

### Advantageous Effects of Invention

The molded article and the production method of the above-mentioned aspects make it possible to obtain a molded article having clear printing generated by laser-making. The laser marking method of the above-mentioned aspect makes it possible to obtain a molded article having clear printing.

### DESCRIPTION OF EMBODIMENTS

Hereinafter, an embodiment for carrying out the present invention (hereinafter simply referred to as “the present embodiment”) will be described in detail. The present embodiments described below are examples explaining the present invention, and are not intended to limit the present invention to the following contents. The present invention can be appropriately modified and carried out within the scope of the gist thereof.

In the present specification, the term “polyamide” means a polymer having an amide (—NHCO—) group in the main chain thereof.

### <<Molded Article>>

The molded article of the present embodiment is a molded article obtained by molding a resin composition containing a thermoplastic resin (A).

The molded article of the present embodiment has a foam identifying part. In the present specification, the term “foam identifying part” refers to a processed portion in which the surface of a molded article composed of a resin composition is foamed by laser, heat, or the like, thereby generating a difference in color from other portions, which makes it possible to be clearly distinguished from other portions.

Particularly, it is preferable that the foam identifying part of the molded article of the present embodiment be a printed portion generated by laser marking.

In the molded article of the present embodiment, the developed interfacial area ratio Sdr defined by ISO 25178 of the foam identifying part is 0.10 to 1.00, preferably to 0.90, more preferably 0.20 to 0.80, and even more preferably 0.30 to 0.70.

When the developed interfacial area ratio Sdr is within the above-mentioned range, the light scattering efficiency is improved, thereby making the clearness of printing generated by laser marking on the molded article excellent.

The developed interfacial area ratio Sdr is one of the parameters that define the surface roughness of an object and is defined by ISO 25178.

The developed interfacial area ratio Sdr can be measured in accordance with ISO 25178. For example, the developed interfacial area ratio Sdr can be measured by a non-contact method using a laser.

More specifically, the developed interfacial area ratio Sdr can be measured using a laser microscope manufactured by KEYENCE CORPORATION (measurement unit: VK-X210, controller: VK-X200). The developed interfacial area ratio Sdr defined in ISO 25178 can be measured by setting an objective lens with a magnification of 20 times, moving the measuring instrument to the observation point, and starting measurement in the measurement mode “expert”.

In the molded article of the present embodiment, the projection height of the foam identifying part is 6.6 μm to 100.0 μm, preferably 10.0 μm to 90 more preferably 14.0 μm to 80.0 μm, and even more preferably 17.0 μm to 70.0 μm.

When the projection height is within the above-mentioned range, the underlying part of the foam identifying part is hidden and the foam identifying part is suppressed from missing when rubbed, so the clearness of printing generated by laser marking on the molded article becomes excellent.

The projection height is calculated from the difference between the average height of the foam identifying part and the average height of the unprocessed portion in the vicinity thereof. For example, the projection height can be measured by a non-contact method using a laser.

More specifically, the projection height can be measured using a laser microscope manufactured by KEYENCE CORPORATION (measurement unit: VK-X210, controller: VK-X200). The projection height can be measured by setting an objective lens with a magnification of 20 times, moving the measuring instrument to the observation point, and starting measurement in the measurement mode “expert”.

Since the molded article of the present embodiment has the above configuration, the clearness of printing generated by laser marking becomes excellent.

Next, the resin composition that constitutes the molded article of the present embodiment will be described below.

### <Resin Composition>

The resin composition includes a thermoplastic resin (A).

### [Thermoplastic Resin (A)]

Examples of the thermoplastic resin (A) include polyamide-based resins, polyester-based resins, polyacetal-based resins, polycarbonate-based resins, polyacrylic-based resins, and polyphenylene ether-based resins (including modified polyphenylene ethers in which polyphenylene ether is blended or graft-polymerized with other resins), polyarylate-based resin, polysulfone-based resin, polyphenylene sulfide-based resin, polyethersulfone-based resin, polyketone-based resin, polyphenylene ether ketone-based resin, polyimide-based resin, polyamideimide-based resin, polyetherimide-based resins, polyurethane resins, polyolefin-based resins (such as α-olefin (co)polymers), and various ionomers.

The thermoplastic resin (A) is preferably a crystalline resin having a melting point of 100° C. to 350° C., an amorphous resin having a glass transition temperature of 50° C. to 250° C., or a combination thereof.

The melting point of the crystalline resin referred to here is the peak top temperature of the endothermic peak that appears when the temperature is raised from 23° C. at a rate of 10° C./min using a differential scanning calorimeter (DSC). When two or more endothermic peaks appear, the peak top temperature of the endothermic peak on the highest temperature side is indicated. The enthalpy of the endothermic peak at this time is desirably 10 J/g or more, and desirably 20 J/g or more. In the measurement, it is desirable to use a sample obtained by heating the sample once to a temperature condition higher than the melting point by +20° C. or more to melt the resin and then cooling the resultant to 23° C. at a rate of 10° C./min.

In addition, the glass transition temperature Tg of the amorphous resin referred to here is the peak top temperature of the peak at which the storage elastic modulus greatly decreases and the loss elastic modulus is maximized when measured at an applied frequency of 10 Hz while increasing the temperature from 23° C. at a rate of 2° C./min using a dynamic viscoelasticity measurement device. When two or more peaks of the loss elastic modulus appear, the peak top temperature of the peak on the highest temperature side is measured. The measurement frequency at this time is at least once every 20 seconds in order to improve the measurement accuracy. Although the method of preparing the measurement sample is not particularly limited, it is desirable to use a piece cut out of a hot press molded article from the viewpoint of eliminating the influence of molding strain, and it is desirable that the size (width and thickness) of the cut piece be as small as possible from the viewpoint of heat conduction.

The thermoplastic resin (A) may be a homopolymer or a copolymer.

As the thermoplastic resin (A), one of the above-mentioned resins may be used alone, or at least two thereof may be used in combination. Furthermore, the above-mentioned resin may be modified with at least one compound selected from unsaturated carboxylic acids, acid anhydrides thereof and derivatives thereof, to be used as the thermoplastic resin (A).

As the thermoplastic resin (A), at least one resin selected from the group consisting of polyolefin-based resins, polyamide-based resins, polyester-based resins, polyacetal-based resins, polyacrylic-based resins, polyphenylene ether-based resins, and polyphenylene sulfide-based resins is preferable from the viewpoint of heat resistance, moldability, designability and mechanical properties.

It is preferable that a polyamide-based resin (A1) be contained as the thermoplastic resin (A). As a result, printing generated by laser marking can be made clearer. The polyamide-based resin (A1) may be used alone or in combination with other thermoplastic resins.

(Polyamide-Based Resin (A1))

It is preferable that the polyamide-based resin (A1) be a semi-aromatic polyamide (A1-2) having an aromatic ring in the skeleton thereof or an alloy composed of an aliphatic polyamide (A1-1) and a semi-aromatic polyamide (A1-2). As a result, printing generated by laser marking can be made clearer. In the case where the polyamide resin (A1) is the alloy, additional different thermoplastic resins may be used to form an alloy composed of at least three compounds as the thermoplastic resin (A).

In the case where the polyamide-based resin (A1) is the above-mentioned alloy, each amount of the aliphatic polyamide (A1-1) and the semi-aromatic polyamide (A1-2) in the polyamide-based resin (A1) is not particularly limited.

Particularly, the amount of the semi-aromatic polyamide (A1-2) relative to 100.0 parts by mass of the total amount of the aliphatic polyamide (A1-1) and semi-aromatic polyamide (A1-2) is preferably 5.0 parts by mass to 100.0 parts by mass, more preferably 5.0 parts by mass to 95.0 parts by mass, even more preferably 10.0 parts by mass to 80.0 parts by mass, and even more preferably, 15.0 parts by mass to 70.0 parts by mass.

The amount of the aliphatic polyamide (A1-1) relative to 100.0 parts by mass of the total amount of the aliphatic polyamide (A1-1) and semi-aromatic polyamide (A1-2) is preferably 0.0 parts by mass to 95.0 parts by mass, more preferably 5.0 parts by mass to 95.0 parts by mass, even more preferably 7.0 parts by mass to 80.0 parts by mass, and even more preferably 9.0 parts by mass to 70.0 parts by mass.

The clearness of the printing generated by laser marking is further improved by making each amount of the aliphatic polyamide (A1-1) and the semi-aromatic polyamide (A1-2) relative to 100 parts by mass of the total amount of the polyamide (A1-1) and the semi-aromatic polyamide (A1-2) within the above-mentioned range.

(1) Aliphatic Polyamide (A1-1)

It is preferable that the constituent unit of the aliphatic polyamide (A1-1) satisfy at least one of the following conditions (1) and (2).

(1) An aliphatic dicarboxylic acid unit (A1-1a) and an aliphatic diamine unit (A1-1b) are contained.

(2) At least one constituent unit (A1-1c) selected from the group consisting of lactam units and aminocarboxylic acid units is contained.

The constituent units of the aliphatic polyamide (A1-1) may contain at least one polyamide that satisfies at least one of the above-mentioned conditions (1) and (2). Among them, the constituent unit of the aliphatic polyamide (A1-1) preferably satisfies the above-mentioned condition (1).

(1-1) Aliphatic Dicarboxylic Acid Unit (A1-1a)

Examples of the aliphatic dicarboxylic acid that constitutes the aliphatic dicarboxylic acid unit (A1-1a) include C3-20 linear or branched saturated aliphatic dicarboxylic acids.

Although the C3-20 linear saturated aliphatic dicarboxylic acids are not limited to the following compounds, examples thereof include malonic acid, succinic acid, glutaric acid, adipic acid, pimelic acid, suberic acid, azelaic acid, sebacic acid, dodecanedioic acid, tetradecanedioic acid, hexadecanedioic acid, octadecanedioic acid, eicosanedioic acid, and diglycolic acid.

Although the C3-20 branched saturated aliphatic dicarboxylic acids are not limited to the following compounds, examples thereof include dimethylmalonic acid, 2,2-dimethylsuccinic acid, 2,3-dimethylglutaric acid, 2,2-diethylsuccinic acid, 2,3-diethylglutaric acid, 2,2-dimethylglutaric acid, 2-methyladipic acid, and trimethyladipic acid.

One of these aliphatic dicarboxylic acids that constitute the aliphatic dicarboxylic acid units (A1-1a) may be used alone, or at least two thereof may be used in combination.

Particularly, a linear saturated aliphatic dicarboxylic acid having 6 or more carbon atoms is preferable as the aliphatic dicarboxylic acid that constitutes the aliphatic dicarboxylic acid unit (A1-1a), because the heat resistance, fluidity, toughness, low water absorption properties, and rigidity of the resin composition tend to be further improved.

Preferable examples of the linear saturated aliphatic dicarboxylic acids having 6 or more carbon atoms include adipic acid, sebacic acid, dodecanedioic acid, tetradecanedioic acid, hexadecanedioic acid, octadecanedioic acid, and eicosanedioic acid.

Among them, adipic acid, sebacic acid or dodecanedioic acid is preferable as the linear saturated aliphatic dicarboxylic acids having 6 or more carbon atoms, from the viewpoint of the heat resistance of the resin composition or the like.

In addition, the aliphatic polyamide (A1-1) may further contain a unit derived from a trivalent or higher-valent carboxylic acid, as needed, within a range in which effects of the molded article of the present embodiment are not impaired. Examples of the trivalent or higher-valent carboxylic acids include trimellitic acid, trimesic acid, and pyromellitic acid. One of these trivalent or higher-valent carboxylic acids may be used alone or at least two thereof may be used in combination.

(1-2) Aliphatic Diamine Unit (A1-1b)

Examples of aliphatic diamines that constitute an aliphatic diamine unit (A1-1b) include C2-20 linear saturated aliphatic diamines and C3-20 branched saturated aliphatic diamines.

Although the C2-20 linear saturated aliphatic diamines are not limited to the following compounds, examples thereof include ethylenediamine, propylenediamine, tetramethylenediamine, pentamethylenediamine, hexamethylenediamine, heptamethylenediamine, octamethylenediamine, nonamethylenediamine, decamethylenediamine, undecamethylenediamine, dodecamethylenediamine, and tridecamethylenediamine.

Although the C3-20 branched saturated aliphatic diamines are not limited to the following compounds, examples thereof include 2-methylpentamethylenediamine (also referred to as 2-methyl-1,5-diaminopentane), 2,2,4-trimethylhexamethylenediamine, 2,4,4-trimethylhexamethylenediamine, 2-methyl-1,8-octanediamine (also referred to as 2-methyloctamethylenediamine), and 2,4-dimethyloctamethylene diamine.

One of these aliphatic diamines that constitute the aliphatic diamine units (A1-1b) may be used alone or at least two thereof may be used in combination.

Among them, the carbon number of the aliphatic diamine that constitutes the aliphatic diamine unit (A1-1b) is preferably 6 to 12, and more preferably 6 to 10. When the carbon number of the aliphatic diamine that constitutes the aliphatic diamine unit (A1-1b) is the above-mentioned lower limit or more, the heat resistance of the molded article is further improved. On the other hand, when the carbon number thereof is the above-mentioned upper limit or less, the crystallinity and releasability of the molded article are further improved.

Preferable examples of the C6-12 linear or branched saturated aliphatic diamine include hexamethylenediamine, 2-methylpentamethylenediamine, and 2-methyl-1,8-octanediamine.

Among them, hexamethylenediamine or 2-methylpentamethylenediamine is preferable as the C6-12 linear or branched saturated aliphatic diamine. The heat resistance and the rigidity of the molded article are further improved by including such an aliphatic diamine unit (A1-1b).

The aliphatic polyamide (A1-1) may further contain a unit derived from a trivalent or higher-valent aliphatic amine, as needed, within a range in which effects of the molded article of the present embodiment are not impaired. Examples of the trivalent or higher-valent aliphatic amines include bishexamethylenetriamine.

(1-3) At least one constituent unit (A1-1c) selected from the group consisting of lactam units and aminocarboxylic acid units

The aliphatic polyamide (A1-1) may contain at least one constituent unit (A1-1c) selected from the group consisting of lactam units and aminocarboxylic acid units. A polyamide having excellent toughness tends to be obtained by including such a unit.

The terms “lactam unit” and “aminocarboxylic acid unit” refer to poly(condensed) lactam and aminocarboxylic acid.

Although lactam that constitutes the lactam unit is not limited to the following compounds, examples thereof include butyrolactam, pivalolactam, ε-caprolactam, caprylolactam, enantholactam, undecanolactam, and laurolactam (dodecanolactam).

Among them, the lactam that constitutes the lactam unit is preferably ε-caprolactam or laurolactam, and more preferably ε-caprolactam. The toughness of the molded article tends to be improved by including such a lactam.

Although the aminocarboxylic acid that constitutes the aminocarboxylic acid unit is not limited to the following compounds, examples thereof include ω-aminocarboxylic acids and α,ω-amino acids, which are lactam ring-opened compounds.

The aminocarboxylic acid that constitutes the aminocarboxylic acid unit is preferably a C4-14 linear or branched saturated aliphatic carboxylic acid substituted with an amino group at the w-position. Although such aminocarboxylic acids are not limited to the following compounds, examples thereof include 6-aminocaproic acid, 11-aminoundecanoic acid, and 12-aminododecanoic acid. Additional examples of the aminocarboxylic acid include para-aminomethyl benzoic acid.

One of these lactams and aminocarboxylic acids that constitute the structural units (A1-1c) may be used alone or at least two thereof may be used in combination.

A weight-average molecular weight can be used as an index of the molecular weight of the aliphatic polyamide (A1-1). The weight-average molecular weight of the aliphatic polyamide is preferably 10000 to 50000, more preferably 17000 to 45000, still more preferably 20000 to 45000, even more preferably 25000 to 45000, particularly preferably 30000 to 45000, and most preferably 35000 to 40000.

When the weight-average molecular weight is within the above-mentioned range, a molded article having a clearer printed portion generated by laser marking can be obtained.

The weight-average molecular weight of the aliphatic polyamide (A1-1) can be measured using, for example, gel permeation chromatography (GPC).

(2) Semi-Aromatic Polyamide (A1-2)

The semi-aromatic polyamide (A1-2) is a polyamide having an aromatic ring in the skeleton thereof and containing a diamine unit and a dicarboxylic acid unit.

The semi-aromatic polyamide (A1-2) preferably contains 10% by mol to 95% by mol of aromatic constituent units, more preferably contains 20% by mol to 90% by mol of aromatic constituent units, and even more preferably contains 30% by mol to 85% by mol of aromatic constituent units, relative to the total constituent units of the semi-aromatic polyamide (A1-2). The term “aromatic constituent unit” as used herein refers to an aromatic diamine unit and an aromatic dicarboxylic acid unit.

Furthermore, the semi-aromatic polyamide (A1-2) preferably contains 10% by mol or more of aromatic dicarboxylic acid units, more preferably contains 30% by mol or more of aromatic dicarboxylic acid units, even more preferably contains 50% by mol or more of aromatic dicarboxylic acid units, and particularly preferably contains 70% by mol or more of aromatic dicarboxylic acid units, relative to 100% by mol of the total dicarboxylic acid units of the semi-aromatic polyamide (A1-2).

When the amount of the aromatic dicarboxylic acid unit is the above-mentioned lower limit or more, the printed portion generated by laser marking becomes clearer.

Although the aromatic dicarboxylic acid unit in the semi-aromatic polyamide (A1-2) is not particularly limited, the aromatic dicarboxylic acid unit is preferably a terephthalic acid unit or an isophthalic acid unit, and more preferably an isophthalic acid unit.

The ratio of the predetermined monomer units that constitute the semi-aromatic polyamide (A1-2) can be measured by nuclear magnetic resonance spectroscopy (1H-NMR) or the like.

Specifically, for example, a semi-aromatic polyamide (A1-2) is heated to be dissolved in heavy hexafluoroisopropanol such that the concentration thereof becomes about 5% by mass, followed by subjecting to ¹H-NMR analysis using a nuclear magnetic resonance spectrometer JNM ECA-500 manufactured by JEOL Ltd., to calculate the integral ratio, thereby obtaining each ratio of a unit derived from an aromatic dicarboxylic acid, a unit derived from a dicarboxylic acid other than the aromatic dicarboxylic acid, a unit derived from an aromatic diamine, and a unit derived from an amine other than the aromatic diamine, which constitute the semi-aromatic polyamide (A1-2).

(2-1) Dicarboxylic Acid Unit (A1-2a)

The dicarboxylic acid unit (A1-2a) that constitutes the semi-aromatic polyamide (A1-2) is not particularly limited, and examples thereof include an aromatic dicarboxylic acid unit, an aliphatic dicarboxylic acid unit, and an alicyclic dicarboxylic acid unit.

(2-1-1) Aromatic Dicarboxylic Acid Unit

Although the aromatic dicarboxylic acid that constitutes the aromatic dicarboxylic acid unit other than the isophthalic acid unit is not limited to the following compounds, examples thereof include dicarboxylic acids each having an aromatic group such as a phenyl group or a naphthyl group. The aromatic group of the aromatic dicarboxylic acid may be unsubstituted or may have a substituent.

Although the substituent is not particularly limited, example thereof include C1-4 alkyl groups, C6-10 aryl groups, C7-10 arylalkyl groups, C7-10 arylalkyl groups, C7-10 alkylaryl groups, halogen groups, C1-6 silyl groups, sulfonic acid groups and salts thereof (such as sodium salts).

Although the C1-4 alkyl groups are not limited to the following groups, examples thereof include a methyl group, an ethyl group, a n-propyl group, an isopropyl group, a n-butyl group, an isobutyl group, and a tert-butyl group.

Although the C6-10 aryl groups are not limited to the following groups, examples thereof include a phenyl group and a naphthyl group.

Although the C7-10 arylalkyl groups are not limited to the following groups, examples thereof include a benzyl group.

Although the C7-10 alkylaryl groups are not limited to the following groups, examples thereof include a tolyl group and a xylyl group.

Although the halogen groups are not limited to the following groups, examples thereof include a fluoro group, a chloro group, a bromo group, and a iodo group.

Although the C1-6 silyl groups are not limited to the following groups, examples thereof include a trimethylsilyl group, and a tert-butyldimethylsilyl group.

Among them, the aromatic dicarboxylic acid that constitutes an aromatic dicarboxylic acid unit other than an isophthalic acid unit is preferably a C8-20 aromatic dicarboxylic acid that is unsubstituted or substituted with a predetermined substituent.

Although the C8-20 aromatic dicarboxylic acid that is unsubstituted or substituted with a predetermined substituent is not limited to the following compounds, examples thereof include terephthalic acid, naphthalenedicarboxylic acid, 2-chloroterephthalic acid, 2-methylterephthalic acid, 5-methylisophthalic acid, and 5-sodiumsulfoisophthalic acid.

One of the aromatic dicarboxylic acids that constitute the aromatic dicarboxylic acid units may be used alone or at least two thereof may be used in combination.

(2-1-2) Aliphatic Dicarboxylic Acid Unit

Examples of the aliphatic dicarboxylic acid that constitute the aliphatic dicarboxylic acid unit include C3-20 linear or branched saturated aliphatic dicarboxylic acids.

Although the C3-20 linear saturated aliphatic dicarboxylic acid is not limited to the following compounds, examples thereof include malonic acid, succinic acid, glutaric acid, adipic acid, pimelic acid, suberic acid, azelaic acid, sebacic acid, dodecanedioic acid, tetradecanedioic acid, hexadecanedioic acid, octadecanedioic acid, eicosanedioic acid, and diglycolic acid.

Although the C3-20 branched saturated aliphatic dicarboxylic acid is not limited to the following compounds, examples thereof include dimethylmalonic acid, 2,2-dimethylsuccinic acid, 2,3-dimethylglutaric acid, 2,2-diethylsuccinic acid, 2,3-diethylglutaric acid, 2,2-dimethylglutaric acid, 2-methyladipic acid, and trimethyladipic acid.

(2-1-3) Alicyclic Dicarboxylic Acid Unit

Although the alicyclic dicarboxylic acid that constitutes the alicyclic dicarboxylic acid unit (hereinafter, may be referred to as “alicyclic dicarboxylic acid unit”) is not limited to the following compounds, examples thereof include alicyclic dicarboxylic acids in which the alicyclic structure has 3 to 10 carbon atoms. Among them, the alicyclic dicarboxylic acid is preferably an alicyclic dicarboxylic acid in which the alicyclic structure has 5 to 10 carbon atoms.

Although such an alicyclic dicarboxylic acid is not limited to the following compounds, examples thereof include 1,4-cyclohexanedicarboxylic acid, 1,3-cyclohexanedicarboxylic acid, and 1,3-cyclopentanedicarboxylic acid. Among them, the alicyclic dicarboxylic acid is preferably 1,4-cyclohexanedicarboxylic acid.

One of the alicyclic dicarboxylic acids that constitute the alicyclic dicarboxylic acid units may be used alone or at last two thereof may be used in combination.

An alicyclic group of the alicyclic dicarboxylic acid may be unsubstituted or may have a substituent. Examples of the substituent include C1-4 alkyl groups. Examples of the C1-4 alkyl groups include the same groups as those described in the above “aromatic dicarboxylic acid unit”.

The dicarboxylic acid unit other than the isophthalic acid unit preferably has an aromatic dicarboxylic acid unit, and more preferably has an aromatic dicarboxylic acid having 6 or more carbon atoms.

There is a tendency to obtain a resin composition having improved mechanical properties by using such a dicarboxylic acid. In addition, a molded article having a clearer printed portion generated by laser marking can be obtained.

The dicarboxylic acid that constitutes the dicarboxylic acid unit (A1-2a) in the semi-aromatic polyamide (A1-2) is not limited to the compounds described as the above-mentioned dicarboxylic acids, and may be a compound equivalent to the dicarboxylic acid mentioned above.

The term “compound equivalent to the dicarboxylic acid” as used herein refers to a compound capable of forming the same dicarboxylic acid structure as the dicarboxylic acid structure derived from the above-mentioned dicarboxylic acid. Although such compounds are not limited to the following compounds, examples thereof include dicarboxylic acid anhydrides and dicarboxylic acid halides.

In addition, the semi-aromatic polyamide (A1-2) may further contain a unit derived from a trivalent or higher-valent carboxylic acid, as needed, within a range in which effects of the molded article of the present embodiment are not impaired.

Examples of the trivalent or higher-valent carboxylic acids include trimellitic acid, trimeric acid, and pyromellitic acid. One of these trivalent or higher-valent carboxylic acids may be used alone or at least two thereof may be used in combination.

(2-2) Diamine Unit (A1-2b)

The diamine unit (A1-2b) that constitutes the semi-aromatic polyamide (A1-2) is not particularly limited, and examples thereof include aromatic diamine units, aliphatic diamine units and alicyclic diamine units. Among them, the diamine unit (A1-2b) that constitutes the semi-aromatic polyamide (A1-2) preferably contains a diamine unit having 4 to 10 carbon atoms, and more preferably contains a diamine unit having 6 to 10 carbon atoms.

(2-24) Aliphatic Diamine Unit

Examples of the aliphatic diamine that constitutes the aliphatic diamine unit include C4-20 linear saturated aliphatic diamines.

Although the C4-20 linear saturated aliphatic diamines are not limited to the following compounds, examples thereof include ethylenediamine, propylenediamine, tetramethylenediamine, pentamethylenediamine, hexamethylenediamine, heptamethylenediamine, octamethylenediamine, nonamethylenediamine, decamethylenediamine, undecamethylenediamine, dodecamethylenediamine, and tridecamethylenediamine.

(2-2-2) Alicyclic Diamine Unit Although the alicyclic diamine that constitutes the alicyclic diamine unit (hereinafter, may be referred to as “alicyclic diamine”) is not limited to the following compounds, examples thereof include 1,4-cyclohexanediamine, 1,3-cyclohexanediamine, and 1,3-cyclopentanediamine.

(2-2-3) Aromatic Diamine Unit

The aromatic diamine that constitutes the aromatic diamine unit is not limited to the following compounds, provided that the diamine has an aromatic group. Specific examples of the aromatic diamine include meta-xylylenediamine.

One of these diamines that constitute each diamine unit may be used alone or at least two thereof may be used in combination.

Among them, the diamine unit (A1-2b) is preferably an aliphatic diamine unit, more preferably a C4-10 linear saturated aliphatic diamine unit, even more preferably a C6-10 linear saturated aliphatic diamine unit, and particularly preferably a hexamethylenediamine unit.

There is a tendency to obtain a resin composition having improved mechanical properties by using such a diamine. In addition, a molded article having a clearer printed portion generated by laser marking can be obtained.

The weight-average molecular weight can be used as an index of the molecular weight of the semi-aromatic polyamide (A1-2). The weight-average molecular weight of the semi-aromatic polyamide is preferably 10000 to 50000, more preferably 15000 to 45000, still more preferably 15000 to 40000, even more preferably 17000 to 35000, particularly preferably 17000 to 30000, and most preferably) 8000 to 28000.

When the weight-average molecular weight is within the above-mentioned range, a molded article having clearer printed portions generated by laser marking can be obtained.

The weight-average molecular weight of the semi-aromatic polyamide (A1-2) can be measured using GPC, for example.

(3) Terminal Blocking Agent

Terminals of the polyamide-based resin (A1) may be blocked using a conventionally-known terminal blocking agent.

Such a terminal blocking agent may be added as a molecular weight regulator when a polyamide is produced from the dicarboxylic acid and the diamine, or from at least one selected from the group consisting of the lactam and the aminocarboxylic acid.

Although the terminal blocking agent is not limited to the following compounds, examples thereof include monocarboxylic acids, monoamines, acid anhydrides (such as phthalic anhydride), monoisocyanates, monoesters, and monoalcohols. One of the terminal blocking agents may be used alone, or at least two thereof may be used in combination.

Among them, the terminal blocking agent is preferably a monocarboxylic acid or a monoamine. The thermal stability of the molded article tends to be improved by blocking terminals of the polyamide with the terminal blocking agent.

The monocarboxylic acid available as the terminal blocking agent may be any one having reactivity with an amino group that can be present at the terminal of the polyamide. Although the monocarboxylic acid is not limited to the following compounds, examples thereof include aliphatic monocarboxylic acids, alicyclic monocarboxylic acids, and aromatic monocarboxylic acids.

Examples of the aliphatic monocarboxylic acids include formic acid, acetic acid, propionic acid, butyric acid, valeric acid, caproic acid, caprylic acid, lauric acid, tridecylic acid, myristic acid, palmitic acid, stearic acid, pivalic acid, and isobutyric acid.

Examples of the alicyclic monocarboxylic acids include cyclohexanecarboxylic acid.

Examples of aromatic monocarboxylic acids include benzoic acid, toluic acid, α-naphthalenecarboxylic acid, β-naphthalenecarboxylic acid, methylnaphthalenecarboxylic acid, and phenylacetic acid.

One of these monocarboxylic acids may be used alone or at least two thereof may be used in combination.

In particular, the terminals of the semi-aromatic polyamide (A1-2) are preferably blocked with acetic acid from the viewpoint of fluidity and mechanical strength.

The monoamine available as the terminal blocking agent may be any one having reactivity with a carboxy group that can be present at the terminal of the polyamide. Although the monoamine is not limited to the following compounds, examples thereof include aliphatic monoamines, alicyclic monoamines, and aromatic monoamines.

Examples of the aliphatic monoamines include methylamine, ethylamine, propylamine, butylamine, hexylamine, octylamine, decylamine, stearylamine, dimethylamine, diethylamine, dipropylamine and dibutylamine.

Examples of the alicyclic monoamines include cyclohexylamine and dicyclohexylamine.

Examples of the aromatic monoamines include aniline, toluidine, diphenylamine, and naphthylamine.

One of these monoamines may be used alone, or at least two thereof may be used in combination.

The resin composition containing a polyamide having a terminal blocked with a terminal blocking agent tends to have excellent heat resistance, fluidity, toughness, low water absorption properties, and rigidity.

(4) Preferable Polyamide-Based Resin (A1)

Although the preferable polyamide-based resin (A1) is not particularly limited, examples thereof include: polyamides obtained by polycondensation reaction of lactams, such as polyamide 6, polyamide 11, and polyamide 12; and polyamides obtained as copolymers of diamines and dicarboxylic acids, such as polyamide 66, polyamide 610, polyamide 611, polyamide 612, polyamide 66/6I, polyamide 6T, polyamide 6I, polyamide 6I/6T, polyamide 9T, polyamide 10T, polyamide 2M5T, polyamide MXD6, polyamide 6C, and polyamide 2M5C.

Among these, at least one aliphatic polyamide selected from the group consisting of polyamide 6, polyamide 11, polyamide 12, polyamide 66, polyamide 610, polyamide611, and polyamide 61, or at least one semi-aromatic polyamide selected from the group consisting of polyamide 66/6I, polyamide 6T, polyamide 6I, polyamide 6I/6T, polyamide 9T, and polyamide MXD6 is preferable.

(Method of Producing Polyamide-Based Resin (A1))

When a polyamide-based resin (A1) (aliphatic polyamide (A1-1) and semi-aromatic polyamide (A1-2)) are produced, the addition amount of dicarboxylic acid and the addition amount of diamine are preferably about the same molar amount. The molar ratio of the total diamine relative to the total molar amount of dicarboxylic acids is preferably 0.9 to 1.2, more preferably 0.95 to 1.1, and still more preferably 0.98 to 1.05, in view of the amount of diamine that escapes to the outside of the reaction system during the polymerization reaction.

Although the method of producing a polyamide is not limited to the following method, the method includes the following polymerization step (1) or (2), for example.

(1) A step of polymerizing a combination of a dicarboxylic acid that constitutes a dicarboxylic acid unit and a diamine that constitutes a diamine unit to obtain a polymer.

(2) A step of polymerizing at least one selected from the group consisting of lactams that constitute lactam units and aminocarboxylic acids that constitute aminocarboxylic acid units to obtain a polymer.

In addition, it is preferable that the method of producing a polyamide further include an increasing step in which the polymerization degree of the polyamide is increased after the polymerization step. Furthermore, a blocking step in which terminals of the resultant polymer are blocked with a terminal blocking agent may be included after the polymerization step and the increasing step, as needed.

Specific examples of the method of producing a polyamide include various methods such as the following methods 1) to 4).

1) A method in which dicarboxylic acids-diamine salts, mixtures of dicarboxylic acids and diamines, or an aqueous solution or aqueous suspension of at least one selected from the group consisting of lactams and aminocarboxylic acids are heated to allow polymerization to proceed while maintaining the molten state (hereinafter, may be referred to as “hot melt polymerization method”).

2) A method in which the polymerization degree of a polyamide obtained by the hot melt polymerization method is increased while maintaining a solid state at a temperature of the melting point or lower (hereinafter, may be referred to as “hot melt polymerization/solid phase polymerization method”).

3) A method in which dicarboxylic acids-diamine salts, mixtures of dicarboxylic acids and diamines, or at least one selected from the group consisting of lactams and aminocarboxylic acids are polymerized while maintaining a solid state (hereinafter, may be referred to as “solid phase polymerization method”).

4) A method in which polymerization is conducted using a dicarboxylic acid halide component that is equivalent to the dicarboxylic acid and a diamine component (hereinafter, may be referred to as “solution method”).

Among them, the method of producing a polyamide is preferably a production method including a hot melt polymerization method. In the case where a polyamide is produced by the hot melt polymerization method, it is preferable to maintain a molten state until the polymerization is completed. In order to maintain the molten state, it is necessary to produce a polyamide composition under suitable polymerization conditions. Examples of the polymerization conditions include the following conditions. First, the polymerization pressure in the hot melt polymerization method is controlled to 14 kg/cm² to 25 kg/cm² (gauge pressure), and heating is continued. Then, the pressure in a tank is decreased over 30 minutes or more until the pressure reaches atmospheric pressure (gauge pressure is 0 kg/cm²).

In the method of producing a polyamide, the polymerization mode is not particularly limited, and may be a batch mode or a continuous mode.

A polymerization apparatus used to produce a polyamide is not particularly limited, and a conventionally-known apparatus may be used. Specific examples of the polymerization apparatus include an autoclave reactor, a tumbler reactor, and an extruder reactor (such as a kneader).

Although a method of producing a polyamide by a batch-type hot melt polymerization method will be specifically described below as the method of producing a polyamide, the method of producing a polyamide is not limited to the following method.

First, an aqueous solution containing about 40% by mass to 60% by mass of raw material components of the polyamide (a combination of dicarboxylic acid and diamine, and, as needed, at least one selected from the group consisting of lactams and aminocarboxylic acids) is prepared. Then, the aqueous solution is concentrated to about 65% by mass to 90% by mass in a concentration tank operated at a temperature of 110° C. to 180° C. at a pressure of about 0.035 MPa to 0.6 MPa (gauge pressure), thereby obtaining a concentrated solution.

The resultant concentrated solution is then transferred to an autoclave and heating is continued until the pressure in the autoclave is about 1.2 MPa to 2.2 MPa (gauge pressure).

Then, in the autoclave, the pressure is maintained at about 1.2 MPa to 2.2 MPa (gauge pressure) while removing at least one of water and gas components. Next, when the temperature reaches approximately 220° C. to 260° C., the pressure is decreased to atmospheric pressure (gauge pressure is 0 MPa). Water produced as a by-product can be effectively removed by decreasing the pressure in the autoclave to atmospheric pressure and then reducing the pressure, as needed.

The autoclave is then pressurized with an inert gas such as nitrogen and the polyamide molten material is extruded from the autoclave as a strand. The extruded strand is cooled and cut to obtain polyamide pellets.

### [Filler (B)]

The resin composition preferably further contains a filler (B) in addition to the above-mentioned thermoplastic resin (A). The mechanical properties such as toughness and rigidity of the resin composition can be improved by containing the filler (B).

The filler (B) is not particularly limited, and examples thereof include glass fiber, carbon fiber, calcium silicate fiber, potassium titanate fiber, aluminum borate fiber, glass flake, calcium carbonate, talc, kaolin, mica, hydrotalcite, zinc carbonate, calcium monohydrogen phosphate, wollastonite, zeolite, boehmite, magnesium oxide, calcium silicate, sodium aluminosilicate, magnesium silicate, ketjenblack, acetylene black, furnace black, carbon nanotube, graphite, brass, copper, silver, aluminum, nickel, iron, calcium fluoride, montmorillonite, swelling fluoromica, apatite, and milled fiber.

One of these fillers (B) may be used alone or at least two thereof may be used in combination.

Among them, the filler (B) is preferably glass fiber, carbon fiber, glass flake, talc, kaolin, mica, calcium monohydrogen phosphate, wollastonite, carbon nanotube, graphite, calcium fluoride, montmorillonite, swelling fluoromica, or apatite, from the viewpoint of the rigidity and the strength. The filler (B) is more preferably at least one selected from the group consisting of glass fiber, calcium carbonate, talc, mica, wollastonite, and milled fiber, even more preferably glass fiber or carbon fiber, and particularly preferably glass fiber.

In the case where the filler (B) is glass fiber or carbon fiber, the number-average fiber diameter (d1) is preferably 3 μm to 30 μm. The weight-average fiber length (L) is preferably 100 μm to 5 mm. Furthermore, the aspect ratio ((L)/(d1)) of the number-average fiber diameter (D1) relative to the weight-average fiber length (L) is preferably 10 to 100. The use of the glass fiber or carbon fiber having the above-mentioned structure makes it possible to realize improved properties.

In the case where the filler (B) is glass fiber, the number-average fiber diameter (d1) is more preferably 3 μm to 30 μm or less. The weight-average fiber length (L) is more preferably 103 μm to 5 mm. The aspect ratio ((L)/(d1)) is more preferably 3 to 100.

The number-average fiber diameter and the weight-average fiber length of the filler (B) can be measured using the following method.

First, a molded article is dissolved in a solvent in which a thermoplastic resin (A) is soluble, such as formic acid. Next, for example, 100 or more fillers (B) are arbitrarily selected from the resultant insoluble components. Next, the fillers (B) are observed with an optical microscope, a scanning electron microscope, or the like, to obtain the number-average fiber diameter by dividing the total measured fiber diameter by the number of the fillers (B) measured. Alternatively, the weight-average fiber length may be obtained by dividing the total measured fiber length by the total weight of the fillers (B) measured.

The resin composition preferably contains more than 0 parts by mass and 150.0 parts by mass or less of the filler (B), more preferably contains 10.0 parts by mass to 140.0 parts by mass of the filler (B), even more preferably contains 20.0 parts by mass to 135.0 parts by mass of the filler (B), particularly preferably contains 25.0 parts by mass to 130.0 parts by mass of the filler (B), and most preferably contains 30.0 parts by mass to 100 parts by mass of the filler (B), relative to 100 parts by mass of the thermoplastic resin (A).

When the amount of the filler (B) is the above-mentioned lower limit or more, mechanical properties such as the strength and the rigidity of the molded article tend to be further improved. On the other hand, when the amount of the filler (B) is the above-mentioned upper limit or less, a molded article having a further improved surface appearance and laser-welding strength tends to be obtained.

In particular, when the filler (B) is glass fiber, and the amount of the filler (B) relative to 100 parts by mass of the thermoplastic resin (A) is within the above-mentioned range, the mechanical properties such as the strength and the rigidity tend to be further improved.

[Flame Retardant (C)]

The resin composition preferably further contains a flame retardant (C) in addition to the thermoplastic resin (A).

The flame retardant (C) is not particularly limited, and examples thereof include halogen-based flame retardants containing halogen elements such as chlorine-based flame retardants and bromine-based flame retardants, and phosphorus-based flame retardants that do not contain any halogen elements.

One of these flame retardants (C) may be used alone or at least two thereof may be used in combination. Moreover, the use thereof with a flame-retardant adjuvant makes it possible to further improve the flame retardancy.

The halogen-based flame retardants are preferably brominated polyphenylene ethers (such as poly(di)bromophenylene ether) or brominated polystyrenes (such as polydibromostyrene, polytribromostyrene, or crosslinked brominated polystyrene), and more preferably brominated polystyrenes, from the viewpoint of suppressing the amount of corrosive gas generated during melt processing such as extrusion or molding, and from the viewpoint of realization of flame retardancy and mechanical physical properties such as the toughness and the rigidity.

The amount of bromine in the brominated polystyrene is preferably 5% by mass to 75% by mass relative to the total mass of the brominated polystyrene. When the amount of bromine is the above-mentioned lower limit or more, the amount of bromine required to realize flame retardancy can be satisfied with a smaller amount of brominated polystyrene, and a molded article having excellent heat resistance, fluidity, toughness, low water absorption property and rigidity, as well as further excellent flame retardancy can be obtained without impairing the properties of the polyamide copolymer. When the amount of bromine is the above-mentioned upper limit or less, thermal decomposition is less likely to occur during melt processing such as extrusion or molding, gas generation can be further suppressed, and a molded article having improved heat discoloration resistance can be obtained.

The phosphorus-based flame retardant is not particularly limited as long as it does not contain any halogen elements but contains a phosphorus element. Examples of the phosphorus-based flame retardant include phosphate ester-based flame retardants, melamine polyphosphate-based flame retardants, phosphazene-based flame retardants, phosphinic acid-based flame retardants, and red phosphorus-based flame retardants.

Among them, the flame retardant (C) is preferably a phosphate ester-based flame retardant, a melamine polyphosphate-based flame retardant, a phosphazene-based flame retardant or a phosphinic acid-based flame retardant, and particularly preferably a phosphinic acid-based flame retardant.

Specific examples of phosphinic acid-based flame retardants include phosphinates and diphosphinates.

Examples of the phosphinate include compounds of the following general formula (I) (hereinafter, may be abbreviated as “phosphinate (I)”).

Examples of the diphosphinates include diphosphinates of the following general formula (II) (hereinafter, may be abbreviated as “diphosphinates (II)”).

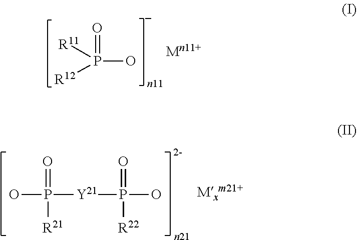

(in the general formula (1), R¹¹ and R¹² are each independently a C1-6 alkyl group or a C6-10 aryl group. Mⁿ¹¹⁺ is an n11-valent metal ion. M is an element in Group 2 or Group 15 of the periodic table, a transition element, zinc or aluminum. n11 is 2 or 3. Multiple R¹¹ and R¹² are identical to or different from each other.

In the general formula (2), R²¹ and R²² are each independently a C1-6 alkyl group or a C6-10 aryl group. Y²¹ is a C1-10 alkylene group or a C6-10 arylene group. M″^{m21+} is an m21-valent metal ion. M′ is an element in Group 2 or Group 15 of the periodic table, a transition element, zinc or aluminum. n21 is an integer of 1 to 3. When n21 is 2 or 3, multiple R²¹, R²² and Y²¹ are identical to or different from each other. m21 is 2 or 3. x is 1 or 2. When x is 2, multiple M′ are identical to or different from each other. n21, x and m21 are integers that satisfy an equation of 2×n21=m21×x.)

(R¹¹, R¹², R²¹ and R²²)

R¹¹, R¹², R²¹ and R²² are each independently a C1-6 alkyl group or a C6-10 aryl group. Although multiple R¹¹ and R¹² are identical to or different from each other, multiple R¹¹ and R¹² are preferably identical to each other from the viewpoint of ease of production. When n21 is 2 or 3, multiple R²¹ and R²² are identical to or different from each other, and are preferably identical to each other from the viewpoint of ease of production.

The alkyl group may be chain-like or cyclic, but is preferably chain-like. The chain-like alkyl group may be linear or branched. Examples of the linear alkyl group include a methyl group, an ethyl group, a n-propyl group, a n-butyl group, a n-pentyl group, and a n-hexyl group. Examples of the branched alkyl group include a 1-methylethyl group, a 1-methylpropyl group, a 2-methylpropyl group, a 1,1-dimethylethyl group, a 1-methylbutyl group, a 2-methylbutyl group, a 3-methylbutyl group, a 1,1-dimethylpropyl group, a 1,2-dimethylpropyl group, a 2,2-dimethylpropyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1-ethylbutyl group, a 2-ethylbutyl group, and a 1,1,2-trimethylpropyl group.

Examples of the aryl group include a phenyl group and a naphthyl group.

The alkyl group and the aryl group may have a substituent. Examples of the substituent of the alkyl group include C6-10 aryl groups. Examples of the substituent of the aryl group include C1-6 alkyl groups.

Specific examples of the alkyl group having a substituent include a benzyl group.

Specific examples of the aryl group having a substituent include a tolyl group and a xylyl group.

Among them, C1-6 alkyl groups are preferable, and a methyl group or an ethyl group is more preferable, as R¹¹, R¹², R²¹ and R²².

### (Y²¹)

Y²¹ is a C1-10 alkylene group or a C6-10 arylene group. When n21 is 2 or 3, multiple Y²¹ are identical to or different from each other, but are preferably identical to each other from the viewpoint of ease of production.

The alkylene group may be chain-like or cyclic, but is preferably chain-like. The chain-like alkylene group may be linear or branched. Examples of the linear alkylene group include a methylene group, an ethylene group, a trimethylene group, a tetramethylene group, a pentamethylene group, and a hexamethylene group. Examples of the branched alkylene group include a 1-methylethylene group and a 1-methylpropylene group.

Examples of the arylene group include a phenylene group, and a naphthylene group.

The alkylene group and the arylene group may have a substituent. Examples of the substituent of the alkylene group include C6-10 aryl groups. Examples of the substituent of the arylene group include C1-6 alkyl groups.

Specific examples of the alkylene group having a substituent include a phenylmethylene group, a phenylethylene group, a phenyltrimethylene group, and a phenyltetramethylene group.

Specific examples of the arylene group having a substituent include a methylphenylene group, an ethylphenylene group, a tert-butylphenylene group, a methylnaphthylene group, an ethylnaphthylene group, and a tert-butylnaphthylene group.

Among them, C1-10 alkylene groups are preferable, and a methylene group or an ethylene group is more preferable as Y²¹.

### (M and M′)

M and M′ are each independently an ion of an element in Group 2 or Group 15 of the periodic table, an ion of a transition element, a zinc ion or an aluminum ion. Examples of the ion of an element in Group 2 of the periodic table include calcium ions and magnesium ions. Examples of the ion of an element in Group 15 of the periodic table include bismuth ions.

When x is 2, multiple M′ are identical to or different from each other, but is preferably identical to each other from the viewpoint of ease of production.

Among them, M and M′ are preferably calcium, zinc or aluminum, and more preferably calcium or aluminum.

(x)

x indicates the number of M′ and is 1 or 2. x may be appropriately selected depending on the type of M′ and the number of diphosphinic acids.

(n11 and n21)

n11 indicates the number of phosphinic acids and the valence of M, and is 2 or 3. n11 may be appropriately selected depending on the type and valence of M.

n21 indicates the number of diphosphinic acids and is an integer of 1 to 3. n21 may be appropriately selected depending on the type and number of M′.

(m21)

m21 indicates the valence of M′ and is 2 or 3.

n21, x and m21 are integers that satisfy an equation of 2×n21=m21×x.

Preferable examples of the phosphinate (1) include calcium dimethylphosphinate, magnesium dimethylphosphinate, aluminum dimethylphosphinate, zinc dimethylphosphinate, calcium ethylmethylphosphinate, magnesium ethylmethylphosphinate, aluminum ethylmethylphosphinate, zinc ethylmethylphosphinate, calcium diethylphosphinate, magnesium diethylphosphinate, aluminum diethylphosphinate, zinc diethylphosphinate, calcium methyl-n-propylphosphinate, magnesium methyl-n-propylphosphinate, aluminum methyl-n-propylphosphinate, zinc methyl-n-propylphosphinate, calcium methanedi(methylphosphinate), magnesium methanedi(methylphosphinate), aluminum methanedi(methylphosphinate), zinc methanedi(methylphosphinate), calcium benzene-1,4-(dimethylphosphinate), magnesium benzene-1,4-(dimethylphosphinate), aluminum benzene-1,4-(dimethylphosphinate), zinc benzene-1,4-(dimethylphosphinate), calcium methylphenylphosphinate, magnesium methylphenylphosphinate, aluminum methylphenylphosphinate, zinc methylphenylphosphinate, calcium diphenylphosphinate, magnesium diphenylphosphinate, aluminum diphenylphosphinate, and zinc diphenylphosphinate. Among them, the phosphinate (I) is preferably calcium dimethylphosphinate, aluminum dimethylphosphinate, calcium diethylphosphinate or aluminum diethylphosphinate, more preferably calcium diethylphosphinate or aluminum diethylphosphinate, and particularly preferably aluminum diethylphosphinate, from the viewpoint of their excellent flame retardancy.

Preferable examples of the diphosphinate (II) include calcium methanedi(methylphosphinate), magnesium methanedi(methylphosphinate), aluminum methanedi(methylphosphinate), zinc methanedi(methylphosphinate), calcium benzene-1,4-di(methylphosphinate), magnesium benzene-1,4-di(methylphosphinate), aluminum benzene-1,4-di(methylphosphinate), and zinc benzene-1,4-di(methylphosphinate).

The amount of the flame retardant (C) relative to 100 parts by mass of the thermoplastic resin (A) is preferably 5.0 parts by mass to 90.0 parts by mass, more preferably 10.0 parts by mass to 80.0 parts by mass, even more preferably 15.0 parts by mass to 70.0 parts by mass, and particularly preferably 20.0 parts by mass to 60.0 parts by mass.

When the amount of the phosphorus-based flame retardant is the above-mentioned lower limit or more, a resin composition having improved flame retardancy can be obtained. On the other hand, when the amount of the phosphorus-based flame retardant is the above-mentioned upper limit or less, a resin composition having improved flame retardancy can be obtained without impairing the properties of the resin composition.

### [Coloring Agent (D)]

The resin composition may further contain a coloring agent (D) in addition to the above-mentioned thermoplastic resin (A).

A commonly-used coloring agent may be blended as the coloring agent (D), whereby the resin composition can be colored in any color tone from black to a light color, and preferably colored in black, gray, or a chromatic color (such as orange color).

The coloring agent (D) is preferably a coloring agent that absorbs laser from the viewpoint that the clearness of the printed portion generated by laser marking is improved. Examples of such coloring agents include carbon black (such as acetylene black, lamp black, thermal black, furnace black, channel black, ketjenblack, gas black, and oil black), graphite, titanium black, and black iron oxide. Among these, carbon black (D1) is preferable in terms of dispersibility, color-developmentability, and cost. One of these coloring agents may be used alone or at least two thereof may be used in combination.

Examples of non-black pigments include various inorganic pigments and organic pigments described below. One of these non-black pigments may be used alone or at least two thereof may be used in combination.

Examples of inorganic pigments include: white pigments such as calcium carbonate, titanium oxide, zinc oxide, and zinc sulfide; yellow pigments such as cadmium yellow, yellow lead, titanium yellow, zinc chromate, ocher, and yellow iron oxide; red pigments such as reddish pigment, umber, red iron oxide and cadmium red; blue pigments such as Prussian blue, ultramarine blue and cobalt blue; and green pigments such as chrome green.

Examples of the organic pigments include azo-based, azomethine-based, methine-based, indathron-based, anthraquinone-based, pyranthrone-based, flavanthrone-based, benzenethrone-based, phthalocyanine-based, quinophthalone-based, perylene-based, perinone-based, dioxazine-based, thioindigo-based, isoindolinone-based, isoindoline-based, pyrrole-based, and quinacridone-based pigments.

The amount of the coloring agent (D) relative to 100 parts by mass of the thermoplastic resin (A) is preferably 0.001 parts by mass to 5.00 parts by mass, and more preferably 0.005 parts by mass to 2.5 parts by mass, and even more preferably 0.01 parts by mass to 1.00 parts by mass or less. When the amount of the coloring agent (D) is the above-mentioned lower limit or more, the heating efficiency by the laser is further improved, and the clearness is further improved. On the other hand, when the amount of the coloring agent (D) is the above-mentioned upper limit or less, it is possible to more effectively prevent carbonization of the resin by heating.

### [Other Additives (E)]

In addition to the thermoplastic resin (A), the resin composition may contain other additives (E) that are conventionally used in resin compositions within a range in which effects of the molded article of the present embodiment are not impaired. Examples of other additives (E) include moldability improvers, deterioration inhibitors, nucleating agents, and heat stabilizers.

Since the amount of the other additives (E) in the resin composition varies depending on the type and use-application of the composition, the amount is not particularly limited provided that effects of the molded article of the present embodiment are not impaired.

### (Moldability Improver)

Although the moldability improver is not particularly limited, examples thereof include higher fatty acids, higher fatty acid metal salts, higher fatty acid esters, and higher fatty acid amides. The moldability improver is also used as a “lubricant agent”.

(1) Higher Fatty Acid

Examples of the higher fatty acids include C8-40 linear or branched saturated or unsaturated aliphatic monocarboxylic acids.

Examples of the C8-40 linear saturated aliphatic monocarboxylic acid include lauric acid, palmitic acid, stearic acid, behenic acid, and montanic acid.

Examples of the C8-40 branched saturated aliphatic monocarboxylic acid include isopalmitic acid and isostearic acid.

Examples of the C8-40 linear unsaturated aliphatic monocarboxylic acid include oleic acid, and erucic acid.

Examples of the C8-40 branched unsaturated aliphatic monocarboxylic acid include isooleic acid.

Among them, the higher fatty acid is preferably a stearic acid or a montanic acid.

(2) Higher Fatty Acid Metal Salt

A higher fatty acid metal salt is a metal salt of a higher fatty acid.

Examples of a metal element in the metal salt include elements in Group 1, elements in Group 2, and elements in Group 3 of the periodic table, zinc, and aluminum.

Examples of the elements in Group 1 of the periodic table include sodium and potassium.

Examples of the elements in Group 2 of the periodic table include calcium and magnesium.

Examples of the elements in Group 3 of the periodic table include scandium and yttrium.

Among them, an element in Group 1 or 2 of the periodic table, or aluminum is preferable, and sodium, potassium, calcium, magnesium or aluminum is more preferable.

Specific examples of the higher fatty acid metal salt include calcium stearate, aluminum stearate, zinc stearate, magnesium stearate, calcium montanate, sodium montanate, and calcium palmitate.

Among them, the higher fatty acid metal salt is preferably a metal salt of montanic acid or a metal salt of stearic acid.

(3) Higher Fatty Acid Ester

The higher fatty acid ester is an esterified product of higher fatty acid and alcohol.

The higher fatty acid ester is preferably an ester of a C8-40 aliphatic carboxylic acid and a C8-40 aliphatic alcohol.

Examples of the C8-40 aliphatic alcohols include stearyl alcohol, behenyl alcohol, and lauryl alcohol.

Specific examples of higher fatty acid esters include stearyl stearate and behenyl behenate.

(4) Higher Fatty Acid Amide

The higher fatty acid amide is an amide compound of a higher fatty acid.

Examples of the higher fatty acid amide include stearic acid amide, oleic acid amide, erucic acid amide, ethylene bis stearic acid amide, ethylene bis oleic acid amide, N-stearyl stearic acid amide, and N-stearyl erucic acid amide.

One of these higher fatty acids, higher fatty acid metal salts, higher fatty acid esters and higher fatty acid amides may be used alone or at least two thereof may be used in combination.

### (Deterioration Inhibitor)

Deterioration inhibitors are used to prevent heat deterioration and discoloration when heated, and to improve heat aging resistance.

Although the deterioration inhibitors are not particularly limited, examples thereof include copper compounds, phenol-based stabilizers, phosphite-based stabilizers, hindered amine-based stabilizers, triazine-based stabilizers, benzotriazole-based stabilizers, benzophenone-based stabilizers, cyanoacrylate-based stabilizers, salicylate-based stabilizers, and sulfur-based stabilizers.

Examples of the copper compounds include copper acetate and copper iodide.

Examples of the phenol-based stabilizers include hindered phenol compounds.

One of these deterioration inhibitors may be used alone or at least two thereof may be used in combination.

### (Nucleating Agent)

The nucleating agent is a substance that exhibits at least one of the following effects (1) to (3) when added.

(1) Effects of raising the crystallization peak temperature of the resin composition.

(2) Effects of reducing the difference between the extrapolated onset temperature and the extrapolated end temperature of the crystallization peak.

(3) Effects of fining spherocrystal of the resultant molded article or making uniform the size thereof.

Although the nucleating agent is not limited to the following compounds, examples thereof include talc, boron nitride, mica, kaolin, silicon nitride, carbon black, potassium titanate, and molybdenum disulfide.

One of the nucleating agents may be used alone or at least two thereof may be used in combination.

Among them, the nucleating agent is preferably talc or boron nitride from the viewpoint of the effects of the nucleating agent.

Moreover, it is preferable that the number-average particle diameter of the nucleating agent be 0.01 μm to 10 μm, since the effect of the nucleating agent is high.

The number-average particle diameter of the nucleating agent can be measured using the following method. First, a molded article is dissolved in a solvent in which the resin composition is soluble, such as formic acid. Then, for example, 100 or more nucleating agents are arbitrarily selected from the resultant insoluble components. Then, observation is conducted with an optical microscope, a scanning electron microscope, or the like to measure the particle diameter.

The amount of the nucleating agent in the resin composition relative to 100 parts by mass of the thermoplastic resin (A) is preferably 0.001 parts by mass to 1 parts by mass, more preferably 0.001 parts by mass to 0.5 parts by mass, and even more preferably 0.001 parts by mass to 0.09 parts by mass.

When the amount of the nucleating agent is the above-mentioned lower limit or more, the heat resistance of the molded article tends to be further improved. In contrast, when the amount of the nucleating agent is the above-mentioned upper limit or less, the toughness of the molded article tends to become further excellent.

### (Heat Stabilizers)

Although the heat stabilizer is not limited to the following compounds, examples thereof include phenol-based heat stabilizers, phosphorus-based heat stabilizers, amine-based heat stabilizers, and metal salts of elements in Group 3, Group 4 and Groups 11 to 14 of the periodic table.

(1) Phenol-Based Heat Stabilizers

Although the phenol-based heat stabilizers are not limited to the following compounds, examples thereof include hindered phenol compounds. The hindered phenol compound has properties that impart excellent heat resistance and light resistance to resins such as polyamides or fibers.

Although the hindered phenol compound is not limited to the following compounds, examples thereof include N,N′-hexane-1,6-diylbis[3-(3,5-di-tert-butyl-4-hydroxyphenylpropionamide), pentaerythrityl-tetrakis[3-(3,5-di-tert-butyl-4-hydroxyphenyl)propionate], N,N′-hexamethylenebis(3,5-di-tert-butyl-4-hydroxy-hydrocinnamamide), triethylene glycol-bis[3-(3-tert-butyl-5-methyl-4-hydroxyphenyl)propionate], 3,9-bis{2-[3-(3-tert-butyl-4-hydroxy-5-methylphenyl)propynyloxy]-1,1-dimethylethyl}-2,4,8,10-tetraoxaspiro[5,5]undecane, 3,5-di-tert-butyl-4-hydroxybenzylphosphonate-diethyl ester, 1,3,5-trimethyl-2,4,6-tris(3,5-di-tert-butyl-4-hydroxybenzyl)benzene, and 1,3,5-tris(4-tert-butyl-3-hydroxy-2,6-dimethylbenzyl)isocyanuric acid.

One of these hindered phenol compounds may be used alone or at least two thereof may be used in combination.

In the case where a phenol-based heat stabilizer is used, the amount of the phenol-based heat stabilizer in the resin composition relative to the total mass of the resin composition is preferably 0.01% by mass to 1% by mass, and more preferably by mass to 1% by mass.

When the amount of the phenol-based heat stabilizer is within the above-mentioned range, it is possible to further improve the heat aging resistance of the molded article and to further reduce the amount of gas generated.

(2) Phosphorus-Based Heat Stabilizers

Although the phosphorus-based heat stabilizers are not limited to the following compounds, examples thereof include pentaerythritol-type phosphite compounds, trioctyl phosphite, trilauryl phosphite, tridecyl phosphite, octyl diphenyl phosphite, trisisodecyl phosphite, phenyl diisodecyl phosphite, phenyl di(tridecyl) phosphite, diphenyl isooctyl phosphite, diphenyl isodecyl phosphite, diphenyl (tridecyl) phosphite, triphenyl phosphite, tris(nonylphenyl) phosphite, tris(2,4-di-tert-butylphenyl) phosphite, tris(2,4-di-tert-butyl-5-methylphenyl) phosphite, tris(butoxyethyl) phosphite, 4,4′-butylidene-bis(3-methyl-6-tert-butylphenyl-tetra-tridecyl) diphosphite, tetra(C12-C15 mixed alkyl)-4,4′-isopropylidene diphenyl diphosphite, 4,4′-isopropylidenebis(2-tert-butylphenyl)-di(nonylphenyl) phosphite, tris(biphenyl) phosphite, tetra(tridecyl)-1,1,3-tris(2-methyl-5-tert-butyl-4-hydroxyphenyl) butane diphosphite, tetra(tridecyl)-4,4′-butylidenebis(3-methyl-6-tert-butylphenyl) diphosphite, tetra(C1-C15 mixed alkyl)-4,4′-isopropylidene diphenyl diphosphite, tris(mixture of mono- and di-nonylphenyls) phosphite, 4,4′-isopropylidenebis(2-tert-butylphenyl)-di(nonylphenyl) phosphite, 9,10-di-hydro-9-oxa-10-phosphaphenanthrene-10-oxide, tris(3,5-di-tert-butyl-4-hydroxyphenyl) phosphite, hydrogenated-4,4′-isopropylidene diphenyl polyphosphite, bis(octylphenyl)-bis(4,4′-butylidenebis(3-methyl-6-tert-butylphenyl))-1,6-hexanol diphosphite, hexatridecyl-1,1,3-tris(2-methyl-4-hydroxy-5-tert-butylphenyl) diphosphite, tris(4,4′-isopropylidenebis(2-tert-butylphenyl) phosphite, tris(1,3-stearoyloxyisopropyl) phosphite, 2,2-methylenebis(4,6-di-tert-butylphenyl) octyl phosphite, 2,2-methylenebis(3-methyl-4,6-di-tert-butylphenyl) 2-ethylhexyl phosphite, tetrakis (2,4-di-tert-butyl-5-methylphenyl)-4,4′-biphenylene diphosphite, and tetrakis(2,4-di-tert-butylphenyl)-4,4′-biphenylene diphosphate.

One of these phosphorus-based heat stabilizers may be used alone or at least two thereof may be used in combination.

Although the pentaerythritol-type phosphite compound is not limited to the following compounds, examples thereof include 2,6-di-tert-butyl-4-methylphenyl-phenyl-pentaerythritol diphosphite, 2,6-di-tert-butyl-4-methylphenyl-methyl-pentaerythritol diphosphite, 2,6-di-tert-butyl-4-methylphenyl-2-ethylhexyl-pentaerythritol diphosphite, 2,6-di-tert-butyl-4-methylphenyl-isodecyl-pentaerythritol diphosphite, 2,6-di-tert-butyl-4-methylphenyl-lauryl-pentaerythritol diphosphite, 2,6-di-tert-butyl-4-methylphenyl-isotridecyl-pentaerythritol diphosphite, 2,6-di-tert-butyl-4-methylphenyl-stearyl-pentaerythritol diphosphite, 2,6-di-tert-butyl-4-methylphenyl-cyclohexyl-pentaerythritol diphosphite, 2,6-di-tert-butyl-4-methylphenyl-benzyl-pentaerythritol diphosphite, 2,6-di-tert-butyl-4-methylphenyl-ethyl cellosolve-pentaerythritol diphosphite, 2,6-di-tert-butyl-4-methylphenyl-butylcarbitol-pentaerythritol diphosphite, 2,6-di-tert-butyl-4-methylphenyl-octylphenyl-pentaerythritol diphosphite, 2,6-di-tert-butyl-4-methylphenyl-nonylphenyl-pentaerythritol diphosphite, bis(2,6-di-tert-butyl-4-methylphenyl) pentaerythritol diphosphite, bis(2,6-di-tert-butyl-4-ethylphenyl) pentaerythritol diphosphite, 2,6-di-tert-butyl-4-methylphenyl-2,6-di-tert-butylphenyl-pentaerythritol diphosphite, 2,6-di-tert-butyl-4-methylphenyl-2,4-di-tert-butylphenyl-pentaerythritol diphosphite, 2,6-di-tert-butyl-4-methylphenyl-2,4-di-tert-octylphenyl-pentaerythritol diphosphite, 2,6-di-tert-butyl-4-methylphenyl-2-cyclohexylphenyl-pentaerythritol diphosphite, 2,6-di-tert-amyl-4-methylphenyl-phenyl-pentaerythritol diphosphite, bis(2,6-di-tert-amyl-4-methylphenyl) pentaerythritol diphosphite, and bis(2,6-di-tert-octyl-4-methylphenyl)pentaerythritol diphosphite.

One of these pentaerythritol-type phosphite compounds may be used alone or at least two thereof may be used in combination.

In the case where the phosphorus-based heat stabilizer is used, the amount of the phosphorus-based heat stabilizer in the resin composition relative to the total mass of the resin composition is preferably 0.01% by mass to 1% by mass, and more preferably by mass to 1% by mass.

When the amount of the phosphorus-based heat stabilizer is within the above-mentioned range, it is possible to further improve the heat aging resistance of the molded article and to further reduce the amount of gas generated.

(3) Amine-Based Heat Stabilizers

Although the amine-based heat stabilizers are not limited to the following compounds, examples thereof include 4-acetoxy-2,2,6,6-tetramethylpiperidine, 4-stearoyloxy-2,2,6,6-tetramethylpiperidine, 4-acryloyloxy-2,2,6,6-tetramethylpiperidine, 4-(phenylacetoxy)-2,2,6,6-tetramethylpiperidine, 4-benzoyloxy-2,2,6,6-tetramethylpiperidine, 4-methoxy-2,2,6,6-tetramethylpiperidine, 4-stearyloxy-2,2,6,6-tetramethylpiperidine, 4-cyclohexyloxy-2,2,6,6-tetramethylpiperidine, 4-benzyloxy-2,2,6,6-tetramethylpiperidine, 4-phenoxy-2,2,6,6-tetramethylpiperidine, 4-(ethylcarbamoyloxy)-2,2,6,6-tetramethylpiperidine, 4-(cyclohexylcarbamoyloxy)-2,2,6,6-tetramethylpiperidine, 4-(phenylcarbamoyloxy)-2,2,6,6-tetramethylpiperidine, bis(2,2,6,6-tetramethyl-4-piperidyl)-carbonate, bis(2,2,6,6-tetramethyl-4-piperidyl)-oxalate, bis(2,2,6,6-tetramethyl-4-piperidyl)-malonate, bis(2,2,6,6-tetramethyl-4-piperidyl)-sebacate, bis(2,2,6,6-tetramethyl-4-piperidyl)-adipate, bis(2,2,6,6-tetramethyl-4-piperidyl)-terephthalate, 1,2-bis(2,2,6,6-tetramethyl-4-piperidyloxy)-ethane, ami-bis(2,2,6,6-tetramethyl-4-piperidyloxy)-p-xylene, bis(2,2,6,6-tetramethyl-4-piperidyltolylene-2,4-dicarbamate, bis(2,2,6,6-tetramethyl-4-piperidyl)-hexamethylene-1,6-dicarbamate, tris(2,2,6,6-tetramethyl-4-piperidyl)-benzene-1,3,5-tricarboxylate, tris(2,2,6,6-tetramethyl-4-piperidyl)-benzene-1,3,4-tricarboxylate, 1-[2-{3-(3,5-di-tert-butyl-4-hydroxyphenyl)propionyloxy}butyl]-4-[3-(3,5-di-tert-butyl-4-hydroxyphenyl)propionyloxy]2,2,6,6-tetramethylpiperidine, and condensates of 1,2,3,4-butanetetracarboxylic acid, 1,2,2,6,6-pentamethyl-4-piperidinol and β,β,β,β′-tetramethyl-3,9-[2,4,8,10-tetraoxaspiro(5,5)undecane]diethanol.

One of these amine-based heat stabilizers may be used alone or at least two thereof may be used in combination.

In the case where the amine-based heat stabilizer is used, the amount of the amine-based heat stabilizer in the resin composition relative to the total mass of the resin composition is preferably 0.01% by mass to 1% by mass, and more preferably by mass to 1% by mass.

When the amount of the amine-based heat stabilizer is within the above-mentioned range, it is possible to further improve the heat aging resistance of the molded article and to further reduce the amount of gas generated.

(4) Metal Salts of Elements in Group 3, Group 4, and Groups 11 to 14 of the Periodic Table

The metal salts of elements in Group 3, Group 4, and Groups 11 to 14 of the periodic table are not particularly limited, provided that they are salts of metals belonging to these groups.

Among them, copper salts are preferable from the viewpoint of further improving the heat aging resistance of the molded article. Although such copper salts are not limited to the following compounds, examples thereof include copper acetate, copper propionate, copper benzoate, copper adipate, copper terephthalate, copper isophthalate, copper salicylate, copper nicotinate, copper stearate, and copper complex salts in which copper is coordinated to chelating agents.

Examples of the chelating agents include ethylenediamine and ethylenediaminetetraacetic acid.

One of these copper salts may be used alone or at least two thereof may be used in combination.

Among them, the copper salt is preferably copper acetate. When copper acetate is used, a resin composition that has excellent heat aging resistance and can further effectively suppress metal corrosion of screw or cylinder parts (hereinafter, may be simply referred to as “metal corrosion”) during extrusion can be obtained.

In the case where a copper salt is used as a heat stabilizer, the amount of the copper salt in the resin composition relative to 100 parts by mass of the thermoplastic resin (A) is preferably 0.01 parts by mass to 0.60 parts by mass, and more preferably parts by mass to 0.40 parts by mass.

When the amount of the copper salt is within the above-mentioned range, it is possible to further improve the heat aging resistance of the molded article and to further effectively suppress the precipitation of copper or metal corrosion.

The amount of the copper element derived from the above-mentioned copper salt relative to 10⁶ parts by mass (million parts by mass) of the thermoplastic resin (A) is preferably 10 parts by mass to 2000 parts by mass, more preferably 30 parts by mass to 1500 parts by mass, and even more preferably 50 parts by mass to 500 parts by mass, from the viewpoint of improving the heat aging resistance of the molded article.

One of the components of the heat stabilizers described above may be used alone or at least two thereof may be used in combination.

### [Method of Producing Resin Composition]

A method of producing the resin composition is not particularly limited, provided that the thermoplastic resin (A), and, as needed, the filler (B), the flame retardant (C), the coloring agent (D) and each component of other additives (E) are mixed in the method. Hereinafter, the thermoplastic resin (A), the filler (B), the flame retardant (C), the coloring agent (D) and other additives (E) may be referred to as component (A), component (B), component (C), component (D) and component (E), respectively.

Examples of the method of mixing the component (A), and, as needed, the components (B) to (E), described above, include the following methods (1) and (2).

(1) A method in which the component (A) and, as needed, the components (B) to (E) are mixed using a HENSCHEL mixer or the like, and supplied to a single-screw or twin-screw extruder to be melt-kneaded.

(2) A method in which the component (A), and, as needed, the components (C) to (E) are mixed in advance using a HENSCHEL mixer or the like to prepare a mixture, and the mixture is supplied to a single-screw or twin-screw extruder to be melt-kneaded, followed by arbitrarily blending the component (B) from a side feeder of the extruder.

In the method of supplying the components that constitute the resin composition to a melt kneader, all of the constituent components may be supplied to the same supply port at once, or the constituent components may be supplied from different supply ports.

In the case where the polyamide (A1) contains an aliphatic polyamide (A1-1), the melt-kneading temperature is preferably set at a temperature that is higher than the melting point of the aliphatic polyamide (A1-1) by about 1° C. to 100° C., and more preferably by about 10° C. to 50° C.

The shear rate in the kneader is preferably about 100 sec⁻¹ or more. The average residence time during kneading is preferably about 0.5 minutes to 5 minutes.

A conventionally-known device may be used as a melt-kneading device, and examples thereof include a single-screw or twin-screw extruder, a Banbury mixer, a melt-kneader (such as mixing roll).

The blending amount of each component to produce the resin composition is the same as the amount of each component in the resin composition described above.

### [Physical Properties of Resin Composition]

The glass transition temperature Tg of the resin composition is preferably 75° C. or more, more preferably 75° C. to 220° C., even more preferably 80° C. to 210° C., particularly preferably 85° C. to 200° C., and most preferably 90° C. to 150° C.

When the glass transition temperature Tg of the resin composition is within the above-mentioned range, the glossiness of the molded article and the clearness of printing generated by laser marking are improved.

The glass transition temperature Tg of the resin composition can be measured by, for example, a dynamic viscoelasticity measurement device.

Specifically, for example, when measurement is conducted at an applied frequency of 8 Hz while increasing the temperature from −100° C. to 250° C. at a temperature increase rate of 3° C./min, the peak top temperature of the peak at which the storage elastic modulus is greatly reduced and the loss elastic modulus is the maximum is measured as the glass transition temperature Tg. Specifically, the ratio (E2/E1) of the loss elastic modulus E2 to the storage elastic modulus E1 is defined as tan δ, and the temperature at which tan δ reaches the maximum turning point is defined as the glass transition temperature Tg. When two or more peaks of the loss elastic modulus appear, the peak top temperature of the peak on the highest temperature side is defined as the glass transition temperature Tg. The measurement frequency at this time is at least once every 20 seconds in order to improve the measurement accuracy.

Although there is no particular limitation on the method of preparing the measurement sample, the measurement sample is prepared in accordance with JIS-K7139. It is desirable to use a piece cut out of a hot press molded article from the viewpoint of eliminating the influence of molding strain, and it is desirable that the size (width and thickness) of the cut piece be as small as possible from the viewpoint of heat conduction.

The crystallization peak temperature of the resin composition is preferably 240° C. or less, more preferably 120° C. to 235° C., even more preferably 130° C. to 230° C., and particularly preferably 140° C. to 225° C.

When the crystallization peak temperature of the resin composition is within the above-mentioned range, the glossiness of the molded article and the clearness of printing generated by laser marking are further improved.

The crystallization peak temperature of the resin composition can be measured by DSC, for example.

Specifically, for example, the temperature is increased from 50° C. to 350° C. at a temperature increase rate of 20° C./min, maintained at 350° C. for 3 minutes, decreased from 350° C. to 50° C. at a cooling rate of 20° C./min, maintained at 50° C. for 3 minutes, increased again from 50° C. to 350° C. at a temperature increase rate of 20° C./min, maintained at 350° C. for 3 minutes, and then decreased from 350° C. to 50° C. at a cooling rate of 20° C./min to allow the endothermic peak to appear, thereby determining the peak top temperature of the endothermic peak as the crystallization peak temperature. In the case where two or more endothermic peaks appear, the peak top temperature of the endothermic peak on the highest temperature side is measured as the crystallization peak temperature.

The enthalpy of the endothermic peak at this time is desirably 10 J/g or more, and more desirably 20 J/g or more. In the measurement, it is desirable to use a sample obtained by heating the sample once to a temperature condition higher than the melting point by +20° C. or more to melt the resin, and then cooling the sample to 23° C. at a cooling rate of 10° C./min.

### <Method of Producing Molded Article>

The above-mentioned molded article can be produced by the following method, for example.

Namely, the method of producing a laser marked molded article of the present embodiment (hereinafter, may be simply abbreviated as “the production method of the present embodiment”) includes a step of laser marking a molded article obtained by molding a resin composition containing a thermoplastic resin (A) (hereinafter, referred to as a “laser marking step”).

In the above-mentioned step, laser marking is conducted such that the developed interfacial area ratio Sdr defined by ISO 25178 in a laser marked portion of the molded article is 0.10 to 1.00, and the projection height of the laser marked portion of the molded article is 6.6 μm to 100.0 μm.

Since the production method of the present embodiment has the above-mentioned constitution, a molded article having a clear printed portion generated by laser marking can be obtained.

Namely, the production method of the present embodiment can also be referred to as a laser marking method for forming a clear printed portion in a molded article by laser marking.

### [Laser Marking Step]

Examples of laser used in the laser marking step include carbon dioxide laser, Nd-YAG laser, YAG laser, ruby laser, semiconductor laser, argon laser and excimer laser. Among them, Nd-YAG laser, YAG laser, or semiconductor laser is preferable from the viewpoint of marking properties.

The wavelength of the laser used is usually 193 nm to 1100, preferably three wavelength bands of 220 nm to 250 nm, 520 nm to 550 nm, or 900 nm to 1100 nm, more preferably two wavelength bands of 520 nm to 550 nm or 900 nm to 1100 nm, and even more preferably a wavelength band of 1050 nm to 1070 nm.

When processing is conducted in these wavelength bands, the laser is efficiently absorbed by the coloring agent or the resin, the unevenness of the foamed portion becomes fine, and the Sdr and the projection height are increased.

From the viewpoint of shortening the tact time, the scanning speed of laser marking is usually 10 mm/sec to 5000 mm/sec, preferably 100 mm/sec to 4000 mm/sec, and more preferably 500 mm/sec to 2500 mm/sec.

When the scanning speed is the above-mentioned lower limit or more, it is possible to prevent the Sdr and the projection height from decreasing due to a decrease in the amount of laser absorption, and to further effectively prevent printing from becoming unclear. On the other hand, when the scanning speed is the above-mentioned upper limit or less, it is possible to prevent the amount of laser absorption from becoming excessively large, and to more effectively prevent printing from becoming unreadable due to carbonization by heating.

The processing output of laser marking is usually 1.0 W to 30.0 W, preferably 1.0 W to 20.0 W, and more preferably 1.0 W to 15.0 W.

When the processing output is the above-mentioned lower limit or more, it is possible to prevent the Sdr and the projection height from decreasing due to a decrease in the amount of laser absorption, and to more effectively prevent printing from becoming unclear. On the other hand, when the processing output is the above-mentioned upper limit or less, it is possible to prevent the amount of laser absorption from becoming excessively large, and to further effectively prevent printing from becoming unreadable due to carbonization by heating.

The frequency of laser marking is usually 1 kHz to 1000 kHz, preferably 5 kHz to 750 kHz, and more preferably 10 kHz to 500 kHz.

When the frequency is the above-mentioned lower limit or more, marking is performed without any gaps, and the amount of laser absorption is reduced, thereby making it possible to prevent the Sdr and the projection height from decreasing, and to further effectively prevent printing from becoming unclear. On the other hand, when the frequency is the above-mentioned upper limit or less, it is possible to suppress the marking density from becoming excessively dense, and to further effectively prevent printing from becoming unreadable due to carbonization by heating.

The pitch distance of laser marking is usually 0.1 μm to 500 μm, preferably 1 μm to 250 μm, and more preferably 5 μm to 250 μm.

When the pitch distance is the above-mentioned lower limit or more, it is possible to prevent the amount of laser absorption from becoming excessively large, and to further effectively prevent printing from becoming unreadable due to carbonization by heating. On the other hand, when the pitch distance is the above-mentioned upper limit or less, it is possible to prevent the Sdr and the projection height from decreasing due to the decrease in the amount of laser absorption, and to more effectively prevent printing from becoming unclear.

### [Molding Step]

The production method of the present embodiment may further include a molding step before the laser marking step.

In the molding step, the above-mentioned resin composition is molded to obtain an intermediate molded article that does not have a printed portion generated by laser marking.

The method of obtaining the intermediate molded article is not particularly limited, and a conventionally-known molding method can be used.

Examples of the conventionally-known molding method include extrusion molding, injection molding, vacuum molding, blow molding, injection compression molding, decorative molding, molding of other materials, gas assist injection molding, foam injection molding, low-pressure molding, ultra-thin injection molding. (ultrahigh-speed injection molding), and in-mold composite molding (such as insert molding and outsert molding).

### <Application of Molded Article>

The molded article of the present embodiment may be used for various applications, because the printed portion generated by laser marking is clear.

The molded article of the present embodiment may be preferably used in the automotive field, the electrical and electronic field, the mechanical and industrial field, the office equipment field, or the aviation and space field, for example.

Particularly, the molded article of the present embodiment may be preferably used as an electrical and electronic component in an electrical and electronic field, such as a magnet switch housing, a breaker housing, various switch parts, or a molded article of a connector, and may be more preferably used as a magnet switch housing, a breaker housing, or a molded article of a connector.

An electromagnetic contactor that opens and closes an electric circuit with an electromagnet, a thermal relay that shuts off the circuit when overloaded, an electromagnetic switch that combines these (there are multiple names such as a magnet switch or an air circuit breaker), or a safety breaker or an earth leakage breaker that cuts off the power distribution when current flows at a level of no less than the specified value or an abnormality such as shaking or heat generation is detected (hereinafter, may be collectively referred to as “breaker”) is an electrical and electronic component that is to be incorporated in an electrical wiring, and is essential to ensure the safety of electrical wiring.

These electrical and electronic components require product identification, connection notation to prevent incorrect installation, product safety notation, or the like. Although a method of affixing a seal in which the notation is described has been adopted to indicate these notations, there are restrictions such as the requirement that the surface of the molded article be smooth. Therefore, even in these products, a switch from the conventional method of affixing a seal to the laser marking method is in progress, and clear marking properties are required.

Namely, the molded article of the present embodiment can be preferably used in the above-mentioned electrical and electronic component that requires clear marking properties.

### EXAMPLES

The present invention will be described in detail below with reference to specific examples and comparative examples, but the present invention is not limited to the following examples.

Each constituent component of the resin composition used in molded articles of Examples and Comparative Examples will be described.

### <Constituent Components>

### [Aliphatic Polyamide (A1-1)]

A1-1-1: Polyamide 66

A1-1-2: Polyamide 66/6 copolymer

### [Semi-Aromatic Polyamide (A1-2)]

A1-2-1: Polyamide 6I

A1-2-2: Polyamide 6I/6T (manufactured by Ems under the model number of G 21, in which the amount of isophthalic acid units relative to the total dicarboxylic acid units is 70% by mol, and the molecular weight of which is 27000)

A1-2-3: polyamide 66/6I

### [Filler (B)]

B-1: Glass fiber (GF) (manufactured by Nippon Electric Glass Co., Ltd., under the trade name of “ECS03T275H”, the average fiber diameter of which is 10 μmφ, and the cut length of which is 3 mm)

### [Flame Retardant (C)]

C-1: Phosphinic acid-based flame retardant [aluminum diethylphosphinate (manufactured by CLARIANT under the trade name of “Exolit OP1230”)]

### [Coloring Agent (D)]

D1: Carbon black (the primary particle diameter of which is 27 nm)

### [Other Additives (E)]

E-2: Titanium oxide (the particle diameter of which is 210 nm)

### <Production of Polyamide>

Each method of producing the aliphatic polyamide A1-1-1, the semi-aromatic polyamide A1-2-1, and the semi-aromatic polyamide A1-2-3 will be described below in detail. The aliphatic polyamide A1-1-1, the semi-aromatic polyamide A1-2-1, and the semi-aromatic polyamide A1-2-3 obtained by the following production method were dried in a nitrogen gas flow and then the moisture ratio thereof was adjusted to about 0.2% by mass to be used as raw materials of the resin compositions used in molded articles of Examples and Comparative Examples described below.

### Synthesis Example 1

### (Synthesis of Aliphatic Polyamide A1-1-1 (Polyamide66))

The polymerization reaction of polyamide was carried out as follows by the “hot melt polymerization method”.

First, 1,500 g of an equimolar salt of adipic acid and hexamethylenediamine was dissolved in 1,500 g of distilled water to prepare a uniform aqueous solution including 50% by mass of equimolar raw material monomers. This aqueous solution was charged into an autoclave having an internal volume of 5.4 L, and the autoclave was purged with nitrogen. Then, the solution was concentrated by removing aqueous vapor gradually until the solution concentration reached 70% by mass, while conducting stirring at a temperature of about 110° C. to 150° C. Then, the internal temperature was raised to 220° C. At this time, the autoclave was pressurized to 1.8 MPa. The resultant was allowed to react for 1 hour while the pressure was maintained at 1.8 MPa by gradually removing aqueous vapor until the internal temperature reached 245° C. The pressure was then reduced over 1 hour. Then, the inside of the autoclave was maintained under a reduced pressure of 650 torr (86.66 kPa) for 10 minutes using a vacuum device. At this time, the final internal temperature of the polymerization was 265° C. Then, the resultant was pressurized with nitrogen to be made into a strand from a bottom spinneret (nozzle), followed by conducting water-cooling and cutting to discharge the resultant in the form of pellets. The pellets were then dried at 100° C. under a nitrogen atmosphere for 12 hours to obtain an aliphatic polyamide A1-1-1 (polyamide 66).

### Synthesis Example 2

### (Synthesis of Aliphatic Polyamide A1-1-2 (Polyamide 66/6 Copolymer))

30 kg of an aqueous solution including 50% by mass of polymerization components that form a polyamide 66/6 (90% by mass/10% by mass) copolymer (an equimolar salt of hexamethylenediamine and adipic acid and ε-caprolactam) was prepared. Then, the aqueous solution was charged into a 40-L autoclave equipped with a stirrer and a discharge nozzle at the bottom, and thoroughly stirred at a temperature of After conducting purging with nitrogen sufficiently, the temperature was raised from 50° C. to about 270° C., while conducting stirring. At this time, the pressure inside the autoclave was approximately 1.8 Mpa in terms of gauge pressure. The polymerization time was adjusted to obtain the predetermined relative viscosity, while removing water from the reaction system to prevent the pressure from exceeding 1.8 MPa, followed by discharging the polymer from the nozzle at the bottom in a strand shape, and conducting water-cooling and cutting to obtain polyamide 66/6 copolymer pellets. The polyamide 66/6 copolymer pellets were vacuum dried at 80° C. for 24 hours.

### Synthesis Example 3

### (Synthesis of Semi-Aromatic Polyamide A1-2-1 (Polyamide 6I))

The polymerization reaction of polyamide was carried out by the “hot melt polymerization method”, as follows.

First, 1500 g of an equimolar salt of isophthalic acid and hexamethylenediamine, and adipic acid, the amount of which was in excess by 1.5% by mol relative to the total components of the equimolar salt, and 0.5% by mol of acetic acid relative to the total components of the equimolar salt were dissolved in 1500 g of distilled water to prepare a uniform aqueous solution containing 50% by mass of the equimolar raw material monomers. Then, the solution was concentrated by removing aqueous vapor gradually until the solution concentration reached 70% by mass while conducting stirring at a temperature of about 110° C. to 150° C. The internal temperature was then raised to 220° C. At this time, the autoclave was pressurized to 1.8 MPa. The resultant was allowed to react for 1 hour while maintaining the pressure at 1.8 MPa by gradually removing aqueous vapor until the internal temperature reached 245° C. The pressure was then reduced over 30 minutes. Then, the inside of the autoclave was maintained under a reduced pressure of 650 torr (86.66 kPa) for 10 minutes using a vacuum device. At this time, the final internal temperature of the polymerization was 265° C. Then, the resultant was pressurized with nitrogen to be made into a strand from a bottom spinneret (nozzle), followed by conducting water-cooling and cutting to discharge the resultant in the form of pellets. The pellets were then dried at 100° C. under a nitrogen atmosphere for 12 hours to obtain an aliphatic polyamide A1-2-1 (polyamide 6I).

### Synthesis Example 4

### (Synthesis of Semi-Aromatic Polyamide A1-2-3 (Polyamide 66/6I))

2.00 kg of an equimolar salt of adipic acid and hexamethylenediamine, 0.50 kg of equimolar salt of isophthalic acid and hexamethylenediamine and 2.5 kg of pure water were charged in a 5-L autoclave and stirred sufficiently. After the autoclave was sufficiently purged with nitrogen, the temperature was raised from room temperature to 220° C. over about 1 hour while conducting stirring. At this time, the internal pressure was 18 kg/cm² G due to the natural pressure of aqueous vapor in the autoclave, but heating was continued while removing water from the reaction system to prevent the pressure from exceeding 18 kg/cm² G. When the internal temperature reached 260° C. after 2 hours, the heating was stopped, the discharge valve of the autoclave was closed, and the autoclave was cooled to room temperature over about 8 hours. After cooling, the autoclave was opened and about 2 kg of polymer was taken out and pulverized. The obtained pulverized polymer was placed in a 10-L evaporator to allow the solid-phase polymerization to proceed at 200° C. for 10 hours under a nitrogen gas flow. Then, the resultant was pressurized with nitrogen to be made into a strand from a bottom spinneret (nozzle), followed by conducting water-cooling and cutting to discharge the resultant in the form of pellets. The pellets were then dried at 100° C. under a nitrogen atmosphere for 12 hours to obtain a semi-aromatic polyamide A1-2-3 (polyamide 66/6I).

### <Preparation of Resin Composition>

### Preparation Example 1

### (Preparation of Resin Composition PA-1)

The aliphatic polyamide A1-1-1, the semi-aromatic polyamide A1-2-1 and a pre-blended carbon black D1 were supplied using a TEM 35 mm twin-screw extruder (set temperature: 280° C., screw rotation speed: 300 rpm) manufactured by Toshiba Machine Company, from a top feed opening provided at the uppermost stream portion of the extruder. Next, the melt-kneaded product extruded from a die head was cooled in a strand form and pelletized to obtain pellets of the resin composition. The blended amount is as shown in Table 1.

### Preparation Examples 2 to 19

### (Preparation of Resin Compositions PA-2 to PA-19)

Each resin composition was prepared by the same method as that of Preparation Example 1 except that the blended amounts of the components (A) to (E) were as shown in Tables 1 to 3, and the filler B-1 was supplied from a side feed opening provided at the downstream side of the extruder (in a state in which the resin supplied from the top feed opening was sufficiently melt).

Constitutions of the resultant resin compositions PA-1 to PA-19 are shown in Tables 1 to 3.

TABLE 1

| | | Preparation Example | | | | | |
|---|---|---|---|---|---|---|---|
| | | 1 | 2 | 3 | 4 | 5 | 6 |
| | | Resin composition | | | | | |
| | | PA-1 | PA-2 | PA-3 | PA-4 | PA-5 | PA-6 |
| Thermoplastic | Aliphatic polyamide | 13.0 | 13.0 | 29.0 | 73.0 | 90.0 | 72.0 |
| resin (A) | (A1-1-1) | | | | | | |
| (parts by mass) | Semi-aromatic | 87.0 | 87.0 | 71.0 | 27.0 | 10.0 | 28.0 |
| | polyamide (A1-2-1) | | | | | | |
| | Semi-aromatic | | | | | | |
| | polyamide (A1-2-2) | | | | | | |
| | Semi-aromatic | | | | | | |
| | polyamide (A1-2-3) | | | | | | |
| Filler (B) | Glass fiber (B-1) | | 11.0 | 33.0 | 33.0 | 33.0 | 95.0 |
| (parts by mass) | | | | | | | |
| Flame retardant (C) | Flame retardant (C-1) | | | | | | |
| (parts by mass) | | | | | | | |
| Coloring agent (D) | Carbon black | 0.15 | 0.15 | 0.20 | 0.20 | 0.20 | 0.30 |
| (parts by mass) | (D1) | | | | | | |
| Other additives (E) | Titanium oxide (E-2) | | | | | | |
| (parts by mass) | | | | | | | |
| Total (parts by mass) | | 100.15 | 111.15 | 133.20 | 133.20 | 133.20 | 195.30 |

TABLE 2

| | | Preparation Example | | | | | | |
|---|---|---|---|---|---|---|---|---|
| | | 7 | 8 | 9 | 10 | 11 | 12 | 13 |
| | | Resin composition | | | | | | |
| | | PA-7 | PA-8 | PA-9 | PA-10 | PA-11 | PA-12 | PA-13 |
| Thermoplastic | Aliphatic polyamide | 6.5 | 9.5 | 6.5 | 9.5 | 80.0 | 60.0 | 100.0 |
| resin (A) | (A1-1-1) | | | | | | | |
| (parts by mass) | Semi-aromatic | | | | | 20.0 | 40.0 | |
| | polyamide (A1-2-1) | | | | | | | |
| | Semi-aromatic | | | 93.5 | 90.5 | | | |
| | polyamide (A1-2-2) | | | | | | | |
| | Semi-aromatic | 93.5 | 90.5 | | | | | |
| | polyamide (A1-2-3) | | | | | | | |
| Filler (B) | Glass fiber (B-1) | 33.0 | 90.0 | 33.0 | 95.0 | 46.0 | 130.0 | 33.0 |
| (parts by mass) | | | | | | | | |
| Flame retardant | Flame retardant | | | | | 37.0 | 27.0 | |
| (C) | (C-1) | | | | | | | |
| (parts by mass) | | | | | | | | |
| Coloring agent | Carbon black (D1) | 0.20 | 0.30 | 0.20 | 0.30 | 0.30 | 0.40 | 0.20 |
| (D) | | | | | | | | |
| (parts by mass) | | | | | | | | |
| Other additives | Titanium oxide(E-2) | | | | | | | |
| (E) | | | | | | | | |
| (parts by mass) | | | | | | | | |
| Total (parts by mass) | | 133.20 | 190.30 | 133.20 | 195.30 | 183.30 | 257.40 | 133.20 |

TABLE 3

| | | Preparation Example | | | | | |
|---|---|---|---|---|---|---|---|
| | | 14 | 15 | 16 | 17 | 18 | 19 |
| | | Resin composition | | | | | |
| | | PA-14 | PA-15 | PA-16 | PA-17 | PA-18 | PA-19 |
| Thermoplastic | Aliphatic polyamide | 100.0 | 100.0 | 72.0 | 29.0 | 100.0 | |
| resin (A) | (A1-1-1) | | | | | | |
| (parts by mass) | Aliphatic polyamide | | | | | | 100.0 |
| | (A1-1-2) | | | | | | |
| | Semi-aromatic | | | 28.0 | 71.0 | | |
| | Polyamide (A1-2-1) | | | | | | |
| | Semi-aromatic | | | | | | |
| | Polyamide (A1-2-2) | | | | | | |
| | Semi-aromatic | | | | | | |
| | Polyamide (A1-2-3) | | | | | | |
| Filler (B) | Glass fiber (B-1) | 100.0 | 47.0 | 33.0 | 33.0 | 11.0 | |
| (parts by mass) | | | | | | | |
| Flame | Flame retardant | | 42.0 | | | | |
| retardant (C) | (C-1) | | | | | | |
| (parts by mass) | | | | | | | |
| Coloring agent | Carbon black (D1) | 0.30 | 0.30 | 0.20 | 0.01 | 0.15 | 0.30 |
| (D) | | | | | | | |
| (parts by mass) | | | | | | | |
| Other additives | Titanium oxide(E-2) | | | | 0.19 | | |
| (E) | | | | | | | |
| (parts by mass) | | | | | | | |
| Total (parts by mass) | | 200.30 | 189.30 | 133.20 | 133.20 | 111.15 | 100.30 |

### <Physical Properties and Evaluation>

First, the pellets of each resin composition obtained in Preparation Examples 1 to 19 were dried in a nitrogen gas flow to reduce the water content in the resin composition to 500 ppm by mass or less. Next, each physical property of the pellets of each resin composition, the water content of which was adjusted, was measured by the following methods. In addition, each physical property of molded articles described later was measured and evaluated.

### [Physical Property 1]

### (Glass Transition Temperature Tg)

The pellets of each resin composition obtained in Preparation Examples 1 to 18 were molded to obtain a molded article in accordance with JIS-K7139 by using a PS40E injection molding machine manufactured by NISSEI PLASTIC INDUSTRIAL CO., LTD., under injection molding conditions in which the cylinder temperature was set at 290° C., the mold temperature was set at 80° C., injection was conducted for 10 seconds, and cooling was conducted for 10 seconds.

The pellets of the resin composition obtained in Preparation Example 19 were molded to obtain a molded article in accordance with JIS-K7139 by using a PS40E injection molding machine manufactured by NISSEI PLASTIC INDUSTRIAL CO., LTD., under injection molding conditions in which the cylinder temperature was set at 265° C., the mold temperature was set at 80° C., injection was conducted for 10 seconds, and cooling was conducted for 10 seconds.

These molded articles of Preparation Examples 1 to 19 were measured under the following conditions using a dynamic viscoelasticity evaluation device (manufactured by GABO, EPLEXOR500N).

### (Measurement Conditions)

Measurement mode: Tensile

Measurement frequency: 10 Hz

Temperature increase rate: 3° C./min

Temperature range: −100° C. to 250° C.

The ratio (E2/E1) of the loss elastic modulus E2 to the storage elastic modulus E1 was defined as tan δ, and the temperature at which tan δ reached the maximum was defined as the glass transition temperature Tg.

### [Physical Property 2]

### (Crystallization Peak Temperature)

The crystallization peak temperature was measured in accordance with JIS-K7121 using a Diamond-DSC manufactured by PERKINELMER Co., Ltd., as follows. The measurement was performed under a nitrogen atmosphere.

First, about 10 mg of the resin composition was heated from 50° C. to 350° C. at a temperature increase rate of 20° C./min. The temperature was maintained at 350° C. for 3 minutes, and then decreased from 350° C. to 50° C. at a cooling rate of 20° C./min. The temperature was maintained at 50° C. for 3 minutes, and then increased again from 50° C. to 350° C. at a temperature increase rate of 20° C./min. Furthermore, the temperature was maintained at 350° C. for 3 minutes, and then decreased from 350° C. to 50° C. at a cooling rate of 20° C./min. The crystallization peak temperature that appeared at this time was measured.

### [Physical Property 3]

### (Developed Interfacial Area Ratio Sdr of Printed Portion Generated by Laser Marking)

The developed interfacial area ratio Sdr of the printed portion generated by laser making on each molded article was measured by using a laser microscope manufactured by KEYENCE CORPORATION (measurement unit: VK-X210, controller: VK-X200), in which an objective lens with a magnification of 20 times was set, in an expert mode in accordance with ISO 25178.

### [Physical Property 4]

### (Projection Height of Printed Portion Generated by Laser Marking)

The average height of a printed portion generated by laser marking and the vicinity thereof on each molded article was measured by an average step measurement using a laser microscope manufactured by KEYENCE CORPORATION (measurement unit: VK-X210, controller: VK-X200), in which an objective lens with a magnification of 20 times was set, in an expert mode.

### [Evaluation 1]

### (Glossiness)

The 60° gloss (%) of the central portion (the portion in which printing was not generated by laser marking) of each molded article was measured using a gloss meter (IG320 manufactured by HORIBA, Ltd.) in accordance with JIS-K7150. The larger the measured value, the more excellent the glossiness, and the glossiness of 55% or more was judged to be favorable.

### [Evaluation 2]

### (Color Difference)

The chromaticity of each molded article was measured at the printed portion generated by laser marking and at the adjacent unprinted portion (unprocessed portion) using a color meter SC-50μ manufactured by Suga Test Instruments Co., Ltd., with D65 light at 10°. The difference in the chromaticity between the printed portion generated by laser marking and the adjacent unprinted portion (unprocessed portion) was calculated as the color difference ΔE*. The greater the color difference ΔE*, the clearer the printing generated by laser marking, and a color difference ΔE* of 35 or more was judged to be favorable in the clearness of printing generated by laser marking.

### <Preparation of Molded Article>

### Examples 1 to 17 and Comparative Examples 1 to 2

A flat plate molded piece (9 cm×6 cm, thickness 2 mm) was prepared from pellets of each resin composition obtained in Preparation Examples 1 to 18 using an injection molding machine (IS150E manufactured by Toshiba Machine Company) under conditions in which the cooling time was set at 25 seconds, the screw rotation speed was set at 200 rpm, the cylinder temperature was set at 290° C., the mold temperature was set at 80° C., and the injection pressure and the injection speed were appropriately adjusted such that the filling time was in the range of 1.0±0.1 seconds.

A flat plate molded piece (9 cm×6 cm, thickness 2 mm) was prepared from the pellets of the resin composition obtained in Production Example 19, using an injection molding machine (IS150E manufactured by Toshiba Machine Company) under conditions in which the cooling time was set at 25 seconds, the screw rotation speed was set at 200 rpm, the cylinder temperature was set at 265° C., the mold temperature was set at 80° C., and the injection pressure and the injection speed were appropriately adjusted such that the filling time was in the range of 1.0±0.1 seconds.

Then, a printing of a 3 mm×3 mm square was generated by laser marking on each resultant flat plate molded piece using MD-V9920 or MD-S9910 manufactured by KEYENCE CORPORATION to obtain each molded article. In the laser marking conditions, the wavelength was 1064 nm (Examples 1 to 15 and Comparative Examples 1 and 2) or 532 nm (Examples 16 and 17), the scanning speed was 2000 mm/sec (Examples 1 to 15 and Comparative Examples 1 and 2) or 1000 mm/sec (Examples 16 and 17), and the output power was 7.8 W or 9.1 W.

Measurement results and evaluation results of the physical properties of each molded article by the above-mentioned methods are shown in Tables 4 to 6.

TABLE 4

| | | | Example | | | | | |
|---|---|---|---|---|---|---|---|---|
| | | | 1 | 2 | 3 | 4 | 5 | 6 |
| Molded article | | | M-a1 | M-a2 | M-a3 | M-a4 | M-a5 | M-a6 |
| Resin composition | | | PA-1 | PA-2 | PA-3 | PA-4 | PA-5 | PA-6 |
| Laser marking | Wavelength (nm) | | 1064 | 1064 | 1064 | 1064 | 1064 | 1064 |
| conditions | Scanning speed | | 2000 | 2000 | 2000 | 2000 | 2000 | 2000 |
| | (mm/sec) | | | | | | | |
| Physical | Tg (° C.) | | 129 | 129 | 117 | 105 | 100 | 105 |
| properties | Crystallization peak | | Absence | Absence | 156 | 220 | 220 | 215 |
| | temperature(° C.) | | of peak | of peak | | | | |
| | Sdr | 7.8 W | 0.12 | 0.18 | 0.31 | 0.31 | 0.12 | 0.20 |
| | | 9.1 W | 0.19 | 0.19 | 0.30 | 0.41 | 0.24 | 0.27 |
| | Projection | 7.8 W | 25.0 | 33.2 | 37.8 | 10.5 | 6.6 | 11.3 |
| | height | 9.1 W | 18.3 | 38.8 | 42.8 | 21.4 | 10.2 | 14.8 |
| | (μm) | | | | | | | |
| Evaluation | Glossiness | 60° (%) | 88 | 86 | 78 | 77 | 78 | 70 |
| | Color | 7.8 W | 43.7 | 53.5 | 56.3 | 48.0 | 40.5 | 47.5 |
| | difference | 9.1 W | 42.2 | 54.9 | 54.4 | 49.4 | 43.3 | 53.0 |
| | ΔE* | | | | | | | |

TABLE 5

| | | | Example | | | | | |
|---|---|---|---|---|---|---|---|---|
| | | | 7 | 8 | 9 | 10 | 11 | 12 |
| Molded article | | | M-a7 | M-a8 | M-a9 | M-a10 | M-a11 | M-a12 |
| Resin composition | | | PA-7 | PA-8 | PA-9 | PA-10 | PA-11 | PA-12 |
| Laser marking | Wavelength (nm) | | 1064 | 1064 | 1064 | 1064 | 1064 | 1064 |
| conditions | Scanning speed | | 2000 | 2000 | 2000 | 2000 | 2000 | 2000 |
| | (mm/sec) | | | | | | | |
| Physical | Tg (° C.) | | 94 | 93 | 125 | 124 | 105 | 120 |
| properties | Crystallization | | 204 | 205 | 217 | 217 | 205 | 206 |
| | peak temperature(° C.) | | | | | | | |
| | Sdr | 7.8 W | 0.15 | 0.58 | 0.12 | 0.40 | 0.35 | 0.26 |
| | | 9.1 W | 0.26 | 0.68 | 0.30 | 0.52 | 0.41 | 0.29 |
| | | 7.8 W | 7.8 | 21.6 | 14.5 | 26.0 | 17.7 | 17.7 |
| | Projection | 9.1 W | 13.4 | 33.2 | 19.8 | 39.3 | 25.0 | 20.5 |
| | height | | | | | | | |
| | (μm) | | | | | | | |
| Evaluation | Glossiness | 60° (%) | 88 | 69 | 73 | 56 | 73 | 71 |
| | Color | 7.8W | 49.6 | 59.1 | 43.3 | 58.0 | 57.1 | 46.0 |
| | difference | 9.1W | 58.0 | 62.0 | 54.2 | 62.0 | 59.8 | 47.3 |
| | ΔE* | | | | | | | |

TABLE 6

| | | | | | | | | Comparative | |
|---|---|---|---|---|---|---|---|---|---|
| | | | Example | | | | | Example | |
| | | | 13 | 14 | 15 | 16 | 17 | 1 | 2 |
| Molded article | | | M-a13 | M-a14 | M-a15 | M-a16 | M-a17 | M-b1 | M-b2 |
| Resin composition | | | PA-13 | PA-14 | PA-15 | PA-16 | PA-17 | PA-18 | PA-19 |
| Laser marking | Wavelength | | 1064 | 1064 | 1064 | 532 | 532 | 1064 | 1064 |
| conditions | (nm) | | | | | | | | |
| | Scanning | | 2000 | 2000 | 2000 | 1000 | 1000 | 2000 | 2000 |
| | speed | | | | | | | | |
| | (mm/sec) | | | | | | | | |
| Physical | Tg (° C.) | | 79 | 84 | 89 | 105 | 106 | 80 | 80 |
| properties | Crystallization | | 222 | 230 | 220 | 220 | 157 | 218 | 214 |
| | peak temperature(° C.) | | | | | | | | |
| | Sdr | 7.8 W | 0.15 | 0.24 | 0.37 | 0.38 | 0.61 | 0.06 | 0.05 |
| | | 9.1 W | 0.20 | 0.26 | 0.43 | 0.38 | 0.65 | 0.06 | 0.05 |
| | Projection | 7.8 W | 11.3 | 7.9 | 14.5 | 18.5 | 31.3 | 7.0 | 1.5 |
| | height | 9.1 W | 13.6 | 13.2 | 19.5 | 20.7 | 30.3 | 6.5 | 5.0 |
| | (μm) | | | | | | | | |
| Evaluation | Glossiness | 60° (%) | 65 | 61 | 62 | 77 | 81 | 74 | 75 |
| | Color | 7.8 W | 40.8 | 38.6 | 45.9 | 50.3 | 45.0 | 32.4 | 31.2 |
| | difference | 9.1 W | 47.7 | 47.1 | 45.9 | 47.5 | 45.9 | 33.2 | 33.2 |
| | ΔE* | | | | | | | | |

As shown in Tables 4 to 6, the molded articles M-a1 to M-a17 (Examples 1 to 17), in which the Sdr was 0.12 to 0.68 and the protrusion height was 6.6 μm to 42.8 μm, had favorable glossiness and clearness of printed portions generated by laser marking.

In contrast, the molded article M-b1 (Comparative Example 1), in which the Sdr of the printed portion was less than 0.10, had favorable glossiness, but the clearness of the printed portion generated by laser marking was unfavorable. The molded article M-b2 (Comparative Example 2), in which the Sdr of the printed portion was less than 0.10 and the projection height of the printed portion was less than 6.6 urn, had favorable glossiness, but the clearness of the printed portion generated by laser marking was unfavorable.

Thus, it was clarified that a molded article in which the Sdr and the projection height are within the specific ranges exhibits excellent clearness of a printed portion generated by laser marking.

### INDUSTRIAL APPLICABILITY

The molded article of the present embodiment and the production method make it possible to obtain a molded article having clear printing generated by laser-making. The molded article of the present embodiment may be preferably used in the automotive field, the electrical and electronic field, the mechanical and industrial field, the office equipment field, or the aviation and space field, for example.

1. A molded article obtained by molding a resin composition comprising a thermoplastic resin (A), the molded article comprising a foam identifying part, wherein
a developed interfacial area ratio Sdr defined by ISO 25178 in the foam identifying part is 0.10 to 1.00, and
a projection height of the foam identifying part is 6.6 μm to 100.0 μm.

2. The molded article according to claim 1, wherein the thermoplastic resin (A) comprises a polyamide-based resin (A1).

3. The molded article according to claim 2, wherein the polyamide-based resin (A1) is
a semi-aromatic polyamide (A1-2) comprising an aromatic ring in a skeleton thereof, or
an alloy of the semi-aromatic polyamide (A1-2) and an aliphatic polyamide (A1-1).

4. The molded article according to claim 3, wherein the semi-aromatic polyamide (A1-2) comprises 10% by mol or more of isophthalic acid units relative to 100% by mol of all constituent dicarboxylic acid units.

5. The molded article according to claim 1, wherein the resin composition has a glass transition temperature of 75° C. or more.

6. The molded article according to claim 1, wherein the resin composition has a crystallization peak temperature of 240° C. or less.

7. The molded article according to claim 1, wherein the resin composition further comprises a filler (B).

8. The molded article according to claim 7, wherein the resin composition comprises the filler (B) in an amount of more than 0 parts by mass and 150.0 parts by mass or less relative to 100 parts by mass of the thermoplastic resin (A).

9. The molded article according to claim 7, wherein the filler (B) is at least one selected from the group consisting of glass fiber, calcium carbonate, talc, mica, wollastonite, and milled fiber.

10. The molded article according to claim 1, wherein the resin composition further comprises a flame retardant (C).

11. The molded article according to claim 10, wherein the flame retardant (C) is at least one selected from the group consisting of phosphinates and diphosphinates.

12. The molded article according to claim 11, wherein
the phosphinates are compounds of general formula (I), and
the diphosphinates are compounds of general formula (II), 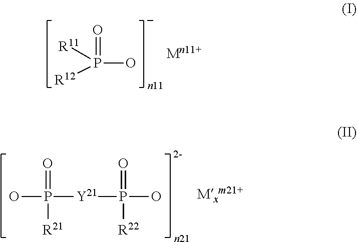
(in the general formula (1), R¹¹ and R¹² are each independently a C1-6 alkyl group or a C6-10 aryl group; Mⁿ¹¹⁺ is an n11-valent metal ion; M is an element in Group 2 or Group 15 of a periodic table, a transition element, zinc or aluminum; n11 is 2 or 3; and multiple R¹¹ and R¹² are identical to or different from each other, and
in the general formula (2), R²¹ and R²² are each independently a C1-6 alkyl group or a C6-10 aryl group; Y 21 is a C1-10 alkylene group or a C6-10 arylene group; M′^{m21+} is an m21-valent metal ion; M′ is an element in Group 2 or Group 15 of the periodic table, a transition element, zinc or aluminum; n21 is an integer of 1 to 3; when n21 is 2 or 3, multiple R²¹, R²² and Y²¹ are identical to or different from each other; m21 is 2 or 3; x is 1 or 2; when x is 2, multiple M′ are identical to or different from each other; and n21, x and m21 are integers that satisfy an equation of 2×n21=m21×x).

13. The molded article according to claim 1, wherein the resin composition further comprises a coloring agent (E) that develops a black, gray, or chromatic color.

14. The molded article according to claim 13, wherein the coloring agent (D) comprises a carbon black (D1), and
an amount of the carbon black (D1) relative to 100 parts by mass of the thermoplastic resin (A) is 0.001 parts by mass to 5.00 parts by mass.

15. The molded article according to claim 1, wherein the molded article is a magnet switch housing, a breaker housing, or a connector molded article.

16. A method of producing a laser marked molded article, comprising:
laser marking a molded article obtained by molding a resin composition comprising a thermoplastic resin (A), such that the laser marking makes a developed interfacial area ratio Sdr defined by ISO 25178 in a laser marked portion of the molded article be 0.10 to 1.00 and a projection height of the laser marked portion of the molded article be 6.6 μm to 100.0 μm.

17. A laser marking method comprising laser marking a molded article obtained by molding a resin composition comprising a thermoplastic resin (A) such that laser marking makes a developed interfacial area ratio Sdr defined by ISO 25178 in a laser marked portion of the molded article be 0.10 to 1.00.
